(19) United States
(12) Patent Application Publication
(10) Pub. No.: US 2008/0055896 A1
(43) Pub. Date: Mar. 6, 2008

(54) Systems, devices, components and methods for controllably configuring the color of light emitted by an automotive LED illumination system

(76) Inventor: David Charles Feldmeier, Redwood City, CA (US)

Correspondence Address: Kathy Manke;Avago Technologies Limited, 4380 Ziegler Road, Fort Collins, CO, 80525, US

(21) Appl. No.: 11/512,845

(22) Filed: Aug. 30, 2006

(51) Int. Cl. F21S 8/10; H05B 33/00; F21V 23/04

(52) U.S. Cl. 362/231; 362/276; 362/464

(57) ABSTRACT

Disclosed are various embodiments of system, devices, components and methods for controllably configuring the color of light emitted by an automotive LED illumination system. The colors of light emitted by LEDs, or clusters or groups of LEDs, may be varied smoothly or in step-wise fashion to produce virtually any desired pattern of collimated light. Such a pattern may be varied in respect of time or space, or both time and space. Light and other types of sensors may be employed to provide feedback control as a further means of controllably configuring the color of light emitted by such a system in response to changes in external and other conditions.

### RELATED APPLICATIONS

Reference is hereby made to U.S. patent application Ser. No. ______ entitled “Systems, Devices, Components and Methods for Controllably Configuring the Brightness of Light Emitted by an Automotive LED Illumination System” to Feldmeier having Avago Technologies Docket No. 10060016-1, and to U.S. patent application Ser. No. ______ entitled “Systems, Devices, Components and Methods for Controllably Configuring the Brightness and Color of Light Emitted by an Automotive LED Illumination System” to Feldmeier having Avago Technologies Docket No. 10060398-1, both of which are hereby incorporated by reference herein, each in its respective entirety, and both of which are filed on even date herewith.

### FIELD OF THE INVENTION

The present invention relates to the field of automotive illumination systems, devices, components and methods.

### BACKGROUND

Automotive illumination systems, devices, components and methods are well known in the art, ubiquitous in everyday life, and have been the subject of constant refinement and development for over a century. Nevertheless, known automotive illumination systems, devices, components and methods suffer from several disadvantages, including their lack of configurability in response to changing environmental or other conditions. Changing the brightness, color of light or pattern of light emitted by an automotive illumination device is generally impossible once the device has been installed in an automobile by its manufacturer. In cases where known automotive illumination devices are configurable, light sources may generally only be turned on or off, or sets of light sources of one color may be turned on or off, while sets of light sources of another color are turned on or off.

What is needed is an automotive illumination system, device, component or method that permits more sophisticated, gradual or finer control and modulation over the brightness and/or color of light emitted by an automotive illumination device, and that may respond to changing external conditions, changing conditions within an automotive cabin, or that may be selectably or controllably configured or updated by a user or manufacturer.

Various patents containing subject matter relating directly or indirectly to the field of the present invention include, but are not limited to, the following:

U.S. Patent. Pub. No. 20020113192 to Antila for “White Illumination,” Aug. 22, 2002.

U.S. Patent. Pub. No. 20040105171 to Minano et al. for “Asymmetric TIR lenses producing off-axis beams,” Jun. 3, 2004.

U.S. Patent. Pub. No. 20040208020 to Ishida for “Vehicle head lamp,” Oct. 21, 2004.

U.S. Patent. Pub. No. 20040223337 to Ishida for “Vehicle head lamp,” Nov. 11, 2004.

U.S. Patent. Pub. No. 20040228131 to Minano et al. for “Optical device for LED-based light-bulb substitute,” Nov. 18, 2004.

U.S. Patent. Pub. No. 20050225988 to Chaves et al. for “Optical device for LED-based lamp,” Oct. 13, 2005.

U.S. Patent. Pub. No. 20050129358 to Minano et al. for “Etendue-squeezing illumination optics,” Jun. 16, 2005.

U.S. Patent. Pub. No. 20050024744 to Falicoff for “Circumferentially emitting luminaires and lens-elements formed by transverse-axis profile-sweeps,” Feb. 3, 2005.

U.S. Patent Pub. No. 20060054776 to Nishimura for “Method and apparatus for regulating the drive currents of a plurality of light emitters,” Mar. 16, 2006.

U.S. Patent. Pub. No. 20060087841 to Chem et al. for “LED luminaire with feedback control,” Apr. 27, 2006.

U.S. Provisional Patent Appln. Ser. No. 60/564,847 to Chaves et al. for “Optical manifolds for light-emitting diodes;” U.S. Provisional Patent. Pub. No. 20050243570.

U.S. Provisional Patent Appln. Ser. No. 60/612,558 to Chaves et al. for “Optical manifolds for light-emitting diodes;” U.S. Provisional Patent. Pub. No. 20050243570.

U.S. Provisional Patent Appln. Ser. No. 60/614,565 to Chaves et al. for “Optical manifolds for light-emitting diodes;” U.S. Provisional Patent. Pub. No. 20050243570.

U.S. Provisional Patent Appln. Ser. No. 60/558,713 to Chaves et al. for “Optical manifolds for light-emitting diodes;” U.S. Provisional Patent. Pub. No. 20050243570.

U.S. Pat. No. 5,685,637 to Chapman for “Dual spectrum illumination system,” Nov. 11, 1997.

U.S. Pat. No. 5,803,579 to Turnbull for “Illuminator assembly incorporating light emitting diodes,” Sep. 8, 1998.

U.S. Pat. No. 6,344,641 to Blalock et al. for “System and method for on-chip calibration of illumination sources for an integrated display,” Feb. 5, 2002.

U.S. Pat. No. 6,406,172 to Harbers et al. for “Headlamp and dynamic lighting system for vehicles,” Jun. 18, 2002.

U.S. Pat. No. 6,448,550 to Nishimura for “Method and apparatus for measuring spectral content of LED light source and control thereof,” Sep. 10, 2002.

U.S. Pat. No. 6,474,837 to Belliveau for “Lighting device with beam altering mechanism incorporating a plurality of light sources,” Nov. 5, 2002.

U.S. Pat. No. 6,565,247 to Thominet for “Illumination device for vehicle,” May 20, 2003.

U.S. Pat. No. 6,626,557 to Taylor for “Multi-colored industrial signal device,” Sep. 30, 2003.

U.S. Pat. No. 6,700,502 to Pederson et al. for “Strip LED light assembly for motor vehicle,” Mar. 2, 2004.

U.S. Pat. No. 6,786,625 to Wesson for “LED light module for vehicles,” Sep. 7, 2004.

U.S. Pat. No. 6,789,930 to Pederson for “LED warning signal light and row of LED's,” Sep. 14, 2004.

U.S. Pat. No. 6,822,578 to Pederson for “Led warning signal light and light bar,” Nov. 23, 2004.

U.S. Pat. No. 6,844,824 to Vukosic for “Multi color and omni-directional warning lamp,” Jan. 18, 2005.

U.S. Pat. No. 6,891,333 to Tatsukawa et al. for “Vehicle headlamp,” May 10, 2005.

U.S. Pat. No. 6,894,442 to Lim et al. for “Luminary control system,” May 17, 2005.

U.S. Pat. No. 6,953,264 to Ter-Hovhannisian for “Vehicle light assembly,” Oct. 11, 2005.

U.S. Pat. No. 6,960,007 to Ishida for “Vehicular headlamp using semiconductor light-emitting elements and manufacturing method thereof,” Nov. 1, 2005.

U.S. Pat. No. 6,976,775 to Koike for “Vehicle lamp,” Dec. 20, 2005.

U.S. Pat. No. 6,991,354 to Brandenburg et al. for “Light-emitting diode module for vehicle headlamps, and a vehicle headlamp,” Jan. 31, 2006.

U.S. Pat. No. 7,009,343 to Lim et al. for “System and method for producing white light using LEDs,” Mar. 7, 2006.

U.S. Pat. No. 7,014,336 to Ducharme for “Systems and methods for generating and modulating illumination conditions,” Mar. 21, 2006.

U.S. Pat. No. 7,019,334 to Yatsuda et al. for “LED lamp for light source of a headlamp,” Mar. 28, 2006.

U.S. Pat. No. 7,040,779 to Lampke et al. for “LED lamp assembly,” May 9, 2006.

U.S. Pat. No. 7,046,160 to Pederson et al. for “LED warning light and communication system,” May 16, 2006.

U.S. Pat. No. 7,059,754 to Lekson et al. for “Apparatus and method for providing a modular vehicle light device,” Jun. 13, 2006.

U.S. Pat. No. 7,059,755 to Yatsuda et al. for “Vehicle lamp,” Jun. 13, 2006.

U.S. Pat. No. 7,070,312 to Tatsukawa for “Lamp unit and vehicle headlamp using the same,” Jul. 4, 2006.

UK Patent Application No. GB 2 326 930 A to Hueppsuff for “Light Source Arrangement,” Jan. 1, 1999.

Japanese Patent Publication No. 2001-266620 to Katsuhiro for “Signal lamp for vehicle,” Feb. 15, 2002

Japanese Patent Publication No. 2002-50215 to Thominet for “Lighting system for vehicle,” Sep. 28, 2001.

The dates of the foregoing publications may correspond to any one of priority dates, filing dates, publication dates and issue dates. Listing of the above patents and patent applications in this background section is not, and shall not be construed as, an admission by the applicants or their counsel that one or more publications from the above list constitutes prior art in respect of the applicant's various inventions. All printed publications and patents referenced herein are hereby incorporated by referenced herein, each in its respective entirety.

Upon having read and understood the Summary, Detailed Descriptions and Claims set forth below, those skilled in the art will appreciate that at least some of the systems, devices, components and methods disclosed in the printed publications listed herein may be modified advantageously in accordance with the teachings of the various embodiments of the present invention.

### SUMMARY

In one embodiment of the present invention, there is provided an automotive illumination system comprising an LED light source and an LED color control circuit operably connected thereto, the color control circuit being configured to control the color of light emitted by the LED light sources between a first color and a second color, the first color being different from the second color.

In another embodiment of the present invention, and in addition to the foregoing elements, there is provided at least one light sensor configured to sense the color of light emitted by the LED light source, the light sensor being operably connected to the color control circuit, the color control circuit, the LED light source and the light sensor comprising a feedback control system for controlling and adjusting the color of light emitted by the LED light source.

In yet another embodiment of the present invention, there is provided an automotive illumination system comprising a plurality of LED light sources and an LED color control circuit operably connected thereto, the color control circuit being configured to control the power spectral distribution of light emitted by the LED light sources between a first power spectral distribution and a second power spectral distribution, where the first power spectral distribution is different from the second power spectral distribution and wavelength-shifted in respect thereof. Such an embodiment of the present invention may further comprise at least one light sensor configured to sense the color of light emitted by the LED light source, the light sensor being operably connected to the color control circuit, the color control circuit, the LED light source and the light sensor comprising a feedback control system for controlling and adjusting the color of light emitted by the LED light source.

Some embodiments of the LED light sources of the present invention may comprise white or phosphor-converted white LEDs, clusters of red, green, blue or other color LEDs, and/or clusters of LEDs comprising at least one LED of a first color and at least one LED of a second color, where the first color is different from the second color. The LEDs of the first and/or second colors may be any one or more an infrared LED, an ultra red LED, a high-efficiency red LED, a super-red LED, a super-orange LED, an orange LED, a super-yellow LED, a super-pure-yellow LED, a yellow LED, an “incandescent” white LED, a pale white LED, a cool white LED, a super-lime-yellow LED, a super-lime-green LED, a high-efficiency green LED, a super-pure-green LED, a pure-green LED, an aqua-green LED, a blue-green LED, super-blue LED, an ultra-blue LED, a violet LED, and a purple LED.

Various embodiments of the present invention may further comprise at least one environmental sensor configured to sense at least one environmental characteristic, the environmental sensor being operably connected to the color control circuit, the color control circuit and the environmental sensor comprising a feedback control system for controlling and adjusting the color of light emitted by the LED light source. The environmental sensor may be at least one of an external lighting level sensor, an automotive cabin lighting level sensor, an on-coming headlight sensor, a rain sensor, a water sensor, a mist sensor, a snow sensor, an ice sensor, a sleet sensor, a fog sensor, a road width sensor, a road condition sensor, a road type sensor, an accelerometer, an automotive speed sensor, a pedestrian sensor, an off-axis vehicle sensor, a moving object sensor, an ignition key sensor, a keyless entry remote control sensor, a door sensor, a trunk sensor, an alarm sensor, a proximity sensor, a seatbelt sensor, an accident sensor, and/or any other type of suitable sensor.

Some embodiments of the present invention may also comprise a color control circuit configurable to vary the color of the LED light source spatially, in respect of time, in respect of time and space, and/or according to at least first and second predetermined patterns. Such color control circuit may further be configured to permit the system to operate as at least one of a headlight, a daytime modulator, a turn signal, a tail light, a brake light, a running light, a fog light and a backup light, or any combination thereof. Such color control circuit may also be configured to permit the system to operate as a low-beam headlight characterized in having a first set of colors when the color control circuit is in a first state, and as high-beam headlight characterized in having a second set of colors when the color control circuit is in a second state, as a headlight characterized in having a first set of colors when the color control circuit is in a first state, and as headlight and a turn signal characterized in having a second set of colors when the color control circuit is in a second state, as a headlight characterized in having a first set of colors when the color control circuit is in a first state, and as headlight and a fog light characterized in having a second set of colors when the color control circuit is in a second state, as a headlight characterized in having a first set of colors when the color control circuit is in a first state, and as a headlight and a running light characterized in having a second set of colors when the color control circuit is in a second state, as a tail light characterized in having a first set of colors when the control circuit is in a first state, and as tail light characterized in having a second set of colors when the control circuit is in a second state, as a tail light when the control circuit is in a first state, and as a tail light and a turn signal when the control circuit is in a second state, as a tail light when the control circuit is in a first state, and as a tail light and a brake light when the control circuit is in a second state, and/or as a tail light when the control circuit is in a first state, and as a backup light when the control circuit is in a second state.

The foregoing embodiments of the present invention may further comprise an optical system for collimating light emitted by LED light source. The system may include a reflector such as a parabolic reflector, an elliptical reflector, a spherical reflector, a spheroidal reflector, an oblate reflector, an oblate spheroidal reflector, a chamfered reflector, and/or a reflective surface. The optical system may also include a lens such as a projection lens, a condenser lens, a concave lens, a convex lens, a planar lens, a plano-concave lens, a piano-convex lens, a translucent lens, a light-guiding lens, an LED lens, an internally-reflecting lens, a fresnel lens, and/or optical mixer. Additionally, the optical system may comprise a shade, a diffuser, a screen, a secondary reflector, a retro-reflector, a secondary reflector, a light guide, and/or an optical manifold.

Some embodiments of the present invention may include a color control circuit comprising user- or manufacturer-controllable means for selecting one or more color levels for the LED light source, manufacturer-controllable hardware or software means for selecting one or more color levels for the LED light source, and/or manufacturer-controllable means for updating or changing software loaded in the control circuit.

The color control circuit of the present invention may comprise at least one of a controller, a micro-controller, a processor, a micro-processor, a processing unit, a CPU, an ASIC, an integrated circuit and a chip, and may be configured to control the amplitude of power spectral distributions of light emitted by the LED light sources between a minimum power spectral distribution amplitude and a maximum power spectral distribution amplitude, where the minimum power spectral distribution amplitude may be configured to be greater than zero. Such circuit may further comprise at least one light sensor configured to sense the color of light emitted by an LED light source, the light sensor being operably connected to the color control circuit, the color control circuit, the LED light source and the light sensor comprising a feedback control system for controlling and adjusting the color of light emitted by the LED light source.

In yet another embodiment of the present invention, there is provided an integrated circuit for an automotive illumination system comprising an LED color control circuit configured to control the color of light emitted by an LED light source between a first color and a second color, where the first color is different from the second color. Such integrated circuit may further comprise at least one signal input means corresponding to the output of a light sensor, the integrated circuit and the at least one signal input means comprising a feedback control system for controlling and adjusting the color of light emitted by the LED light source. The at least one signal input means may be provided by an analog-to-digital converter forming a portion of the integrated circuit. Additionally, the integrated circuit may comprise an LED drive circuit.

In another embodiment of the present invention, there is provided a method of controlling the color of light emitted by an automotive illumination system, the system comprising an LED light source and an LED color control circuit operably connected thereto, the color control circuit being configured to control the color of light emitted by the LED light source between a first color and a second color, the first color being different from the second color, the method comprising adjusting the color of the light emitted by the LED light source.

In still another embodiment of the present invention, there is provided a method of adjusting the color of light emitted by an automotive illumination feedback control system, the system comprising an LED light source and an LED color control circuit operably connected thereto, the color control circuit being configured to control the color of light emitted by the LED light source between a first color and a second color, the first color being different from the second color, and at least one light sensor configured to sense the color of light emitted by the LED light source, the light sensor being operably connected to the color control circuit, the color control circuit, the LED light source and the light sensor comprising a feedback control system for controlling and adjusting the color of light emitted by the LED light source, the method comprising adjusting the color of the light emitted by the LED light source using the feedback control system.

In one embodiment of the present invention, there is provided a method of making an automotive illumination system, the system comprising an LED light source and an LED color control circuit operably connected thereto, the color control circuit being configured to control the color of light emitted by the LED light source between a first color and a second color, the first color being different from the second color, the method comprising providing the automotive illumination system.

In another embodiment of the present invention, there is provided a method of making an automotive feedback control illumination system, the system comprising an LED light source and an LED color control circuit operably connected thereto, the color control circuit being configured to control the color of light emitted by the LED light source between a first color and a second color, the first color being different from the second color, and at least one light sensor configured to sense the color of light emitted by the LED light source, the light sensor being operably connected to the color control circuit, the color control circuit, the LED light source and the light sensor comprising a feedback control system for controlling and adjusting the color of light emitted by the LED light source, the method comprising providing the automotive feedback control illumination system.

In yet another embodiment of the present invention, there is provided a method of installing an automotive illumination system, the system comprising an LED light source and an LED color control circuit operably connected thereto, the color control circuit being configured to control the color of light emitted by the LED light source between a first color and a second color, the first color being different from the second color, the method comprising installing the automotive illumination system in an automobile.

In another embodiment of the present invention, there is provided a method of installing an automotive feedback control illumination system, the system comprising an LED light source and an LED color control circuit operably connected thereto, the color control circuit being configured to control the color of light emitted by the LED light source between a first color and a second color, the first color being different from the second color, and at least one light sensor configured to sense the color of light emitted by the LED light source, the light sensor being operably connected to the color control circuit, the color control circuit, the LED light source and the light sensor comprising a feedback control system for controlling and adjusting the color of light emitted by the LED light source, the method comprising installing the automotive feedback control illumination system in an automobile.

In addition to the foregoing embodiments of the present invention, review of the detailed description and accompanying drawings will show that still other embodiments of the present invention exist. Accordingly, many combinations, permutations, variations and modifications of the foregoing embodiments of the present invention not set forth explicitly herein will nevertheless fall within the scope of the present invention.

### BRIEF DESCRIPTION OF THE DRAWINGS

Different aspects of the various embodiments of the present invention will become apparent from the following specification, drawings and claims in which:

FIG. 1a shows a block diagram of one embodiment of automotive LED illumination system 100;

FIG. 1b shows further illustrative details of one embodiment of LED light source and optical system 400 of the present invention that may be employed in system 100 of FIG. 1a;

FIGS. 2a through 2i illustrate different embodiments of some LED light source and optical systems 400 of the present invention;

FIG. 3a shows light wavelength spectra corresponding to some LEDs that may be employed in the present invention;

FIG. 3b shows a CIE chromaticity diagram;

FIG. 4a shows standard power spectral distributions corresponding to blue, green and red LEDs, and a power spectral distribution resulting from the combination of the light emitted by such LEDs;

FIG. 4b shows power spectral distributions corresponding to different brightness levels in accordance with one embodiment of the present invention;

FIG. 4c shows power spectral distributions corresponding to different colors in accordance with another embodiment of the present invention;

FIG. 4d shows power spectral distributions corresponding to different brightness levels and colors in accordance with yet another embodiment of the present invention;

FIGS. 5a through 5f illustrate various types of outputs that may be achieved using LED brightness control circuit 310 and LED drive circuit 325 of the present invention;

FIGS. 6a through 6e illustrate various types of outputs that may be achieved using LED color control circuit 315 and LED drive circuit 325 of the present invention;

FIG. 7a illustrates one embodiment of a method of controlling and modulating light emitted by an automotive illumination system 100 of the present invention, and

FIG. 7b illustrates another embodiment of a method of controlling and modulating light emitted by an automotive illumination system 100 of the present invention.

The drawings are not necessarily to scale. Like numbers refer to like parts or steps throughout the drawings.

### DETAILED DESCRIPTIONS

In the specification, claims and drawings attached hereto, the following terms have the following meanings:

The term “brightness” means the relative intensity or amplitude of the energy output of light source visible to a human observer, or in the case of some infra-red wavelengths, capable of being detected by an appropriate sensor.

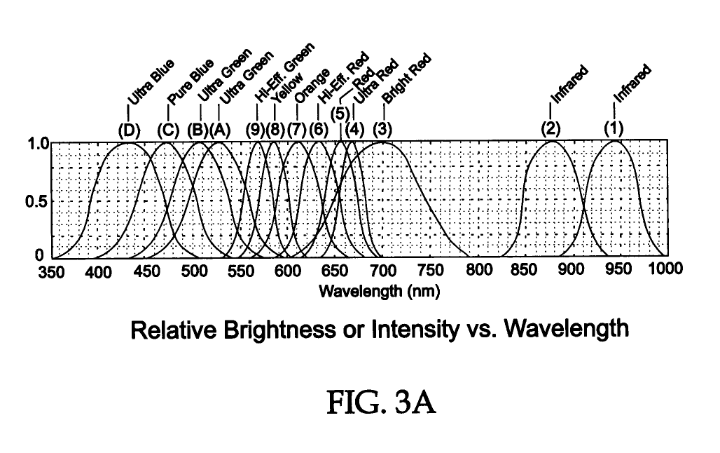

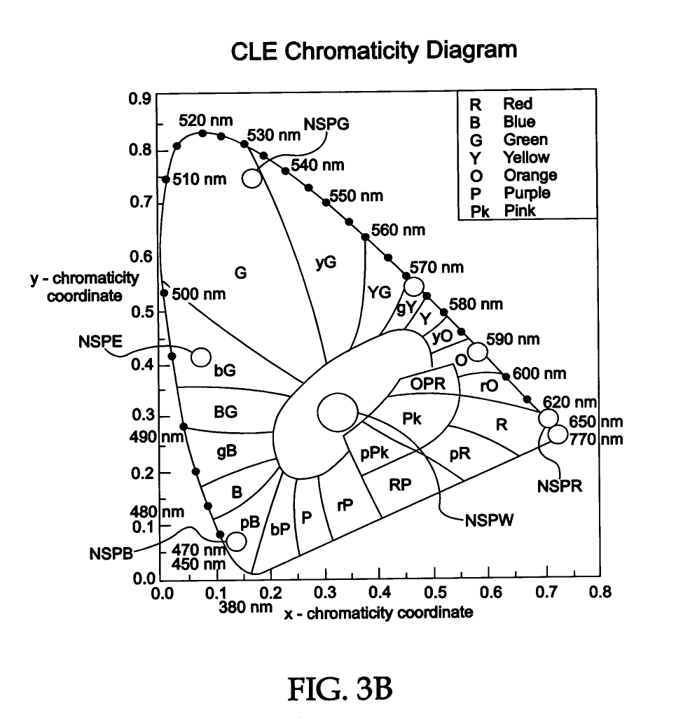

The term “color” means the color of light falling within the spectrum of light visible to a normative human observer and capable of being perceived thereby; different colors are defined by their respective wavelengths and chromaticity as shown in FIGS. 3a and 3b hereof.

The term “LED light source” includes within its scope a light source comprising a plurality of LEDs and/or a plurality of clusters or groups of LEDs.

Set forth below are detailed descriptions of some preferred embodiments of the systems, devices, components and methods of the present invention.

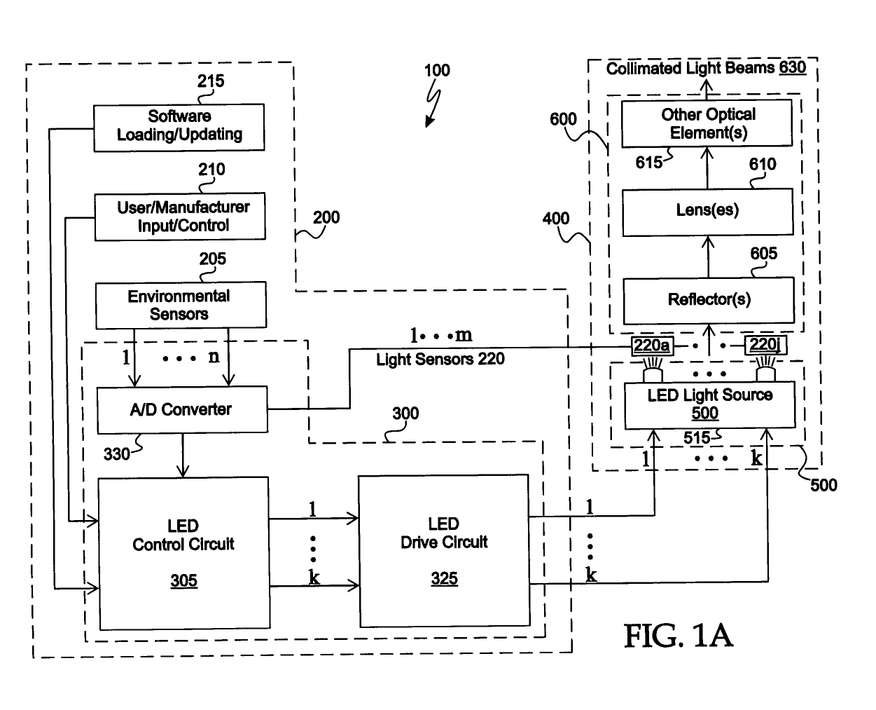

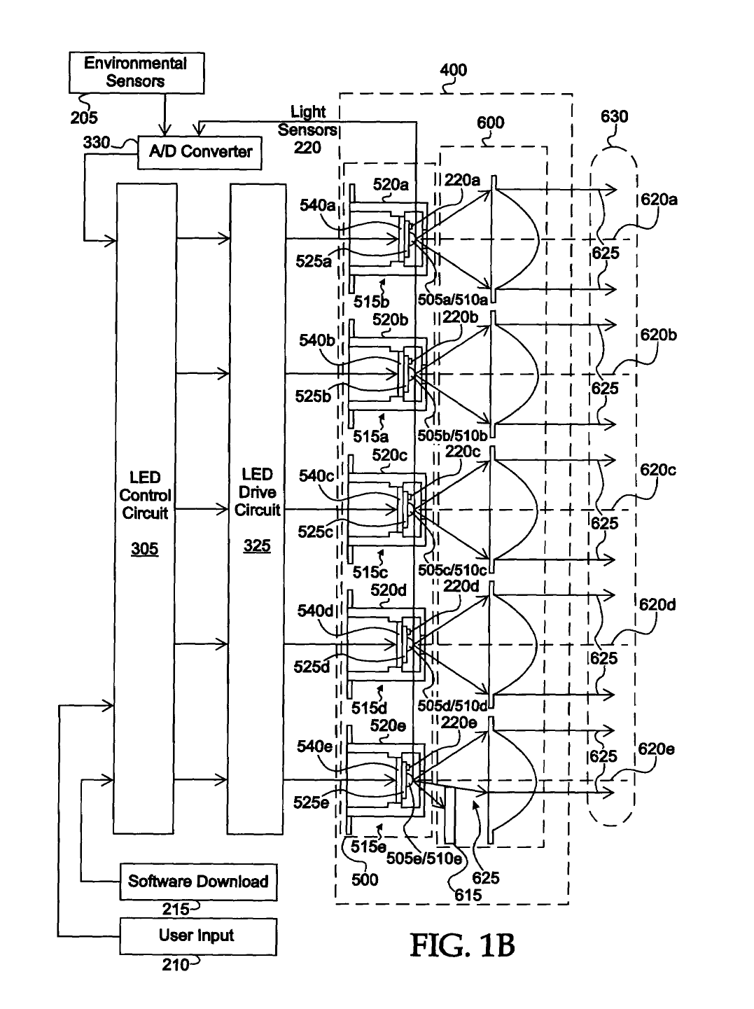

FIG. 1a shows a block diagram of one embodiment of automotive LED illumination system 100, comprising LED illumination control and sensor system 200 and LED light source and optical system 400. LED illumination control and sensor system 200 further comprises LED control and drive circuit 300, environmental sensors 205 providing inputs 1 through n to A/D converter 330, user/manufacturer input/control 210, and software download/update input 215. Light sensors 220 provide inputs 1 through m to A/D converter 330. LED drive and control circuit 300 comprises A/D converter 330, LED control circuit 305 for controlling LEDs 1 through k, and LED drive circuit 325 for driving LEDs in LED light source 500.

LED light source and optical system 400 comprises LED light source 500 and optical assembly 600. LED light source 500 includes LED light source modules or lamp units 515, which contain individual LEDs 505 or clusters or groups of LEDs 510 (not shown individually in FIG. 1a), depending on the particular application at hand. Optical system 600 generally includes one or more of reflectors 605, lenses 610 and other optical elements 615.

Note that automotive illumination system 100 of the present invention may be employed in one or more of automotive headlights, automotive daytime modulators, automotive turn signals, automotive tail lights, automotive brake lights, automotive running lights, automotive fog lights, automotive backup lights, automotive cabin lights, and other automotive illumination applications.

In one embodiment of the present invention, LED control and drive circuit 300 does not include A/D converter 330 or inputs from environmental sensors 205 and light sensors 220. In such an embodiment, LED control and drive circuit 300 operates to controllably configure the brightness, color, and/or color and brightness of light emitted by LED light source 500 without sensing the output of LED light source 500 or of environmental sensors 205, and without using same as feedback control mechanisms for LED control circuit 305.

In another embodiment of the present invention, LED control and drive circuit 300 includes A/D converter 330 and inputs from either or both of environmental sensors 205 and light sensors 220. In such an embodiment, LED control and drive circuit 300 operates to controllably configure the brightness, color, and/or color and brightness of light emitted by LED light source 500 using output signals provided by either or both of source 500 and environmental sensors 205 as feedback control mechanisms for LED control circuit 305.

User/manufacturer input/control 210 and software download/update input 215 are both optional features of the present invention. User/manufacturer input/control 210 may be employed by either a manufacturer of system 100 or by a user of system 100 to controllably configure LED drive control circuit and the resulting spatial, time, or space and time control over the brightness, color, and/or brightness and color of light emitted by LED light source 500. Predetermined patterns or configurations of light emitted by LED light sources 500 may be selected by the manufacturer or user, or such predetermined patterns or configurations may be adjusted by the user or manufacturer. Software download/update input 215 may be used by a manufacturer or technician to load updated or new brightness, color, and/or brightness and color control software into LED control circuit 305.

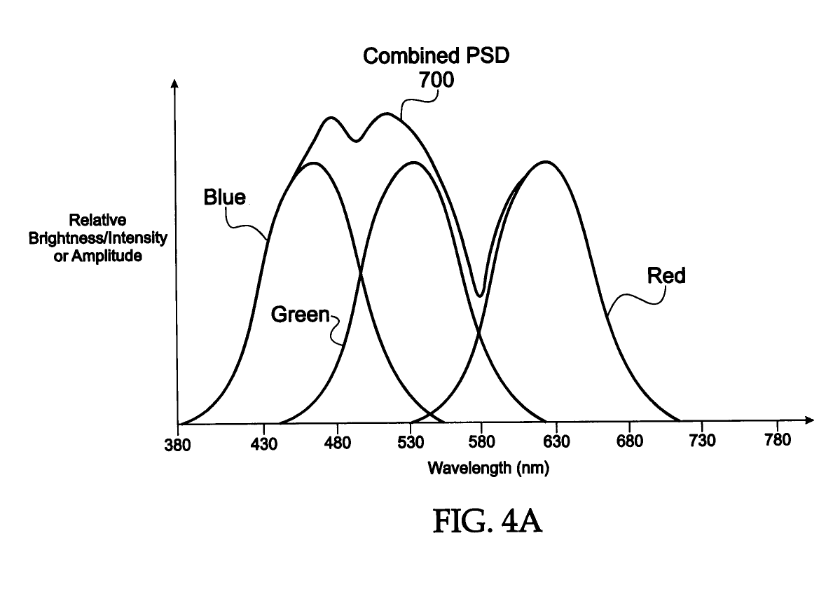

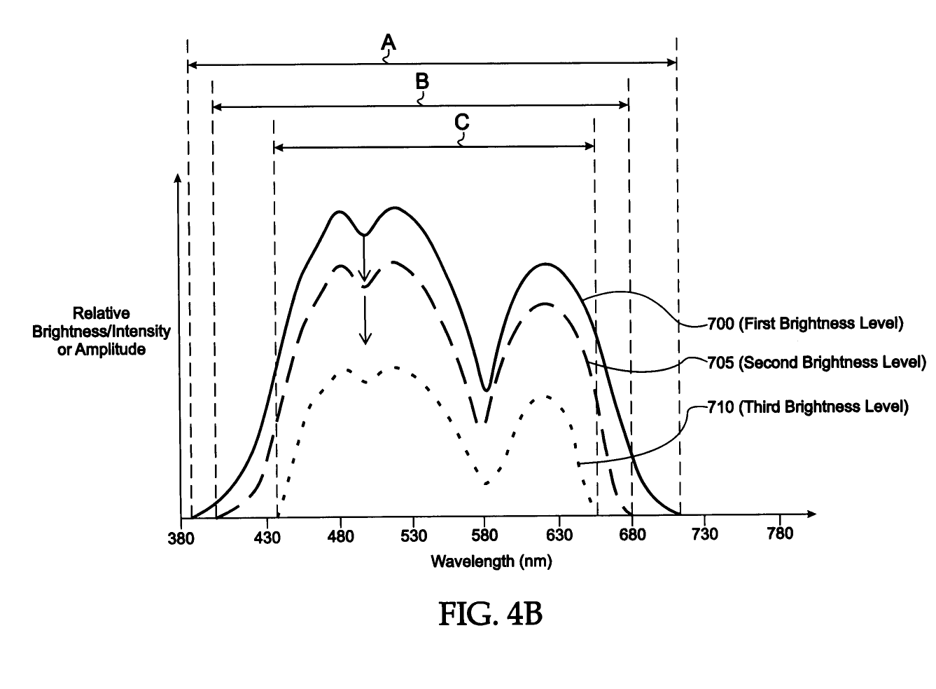

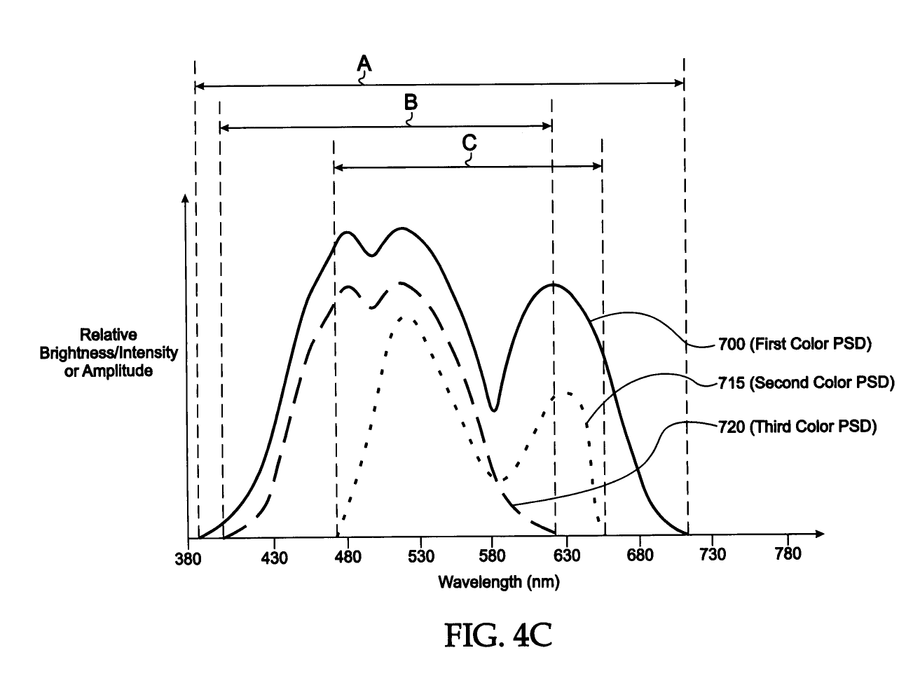

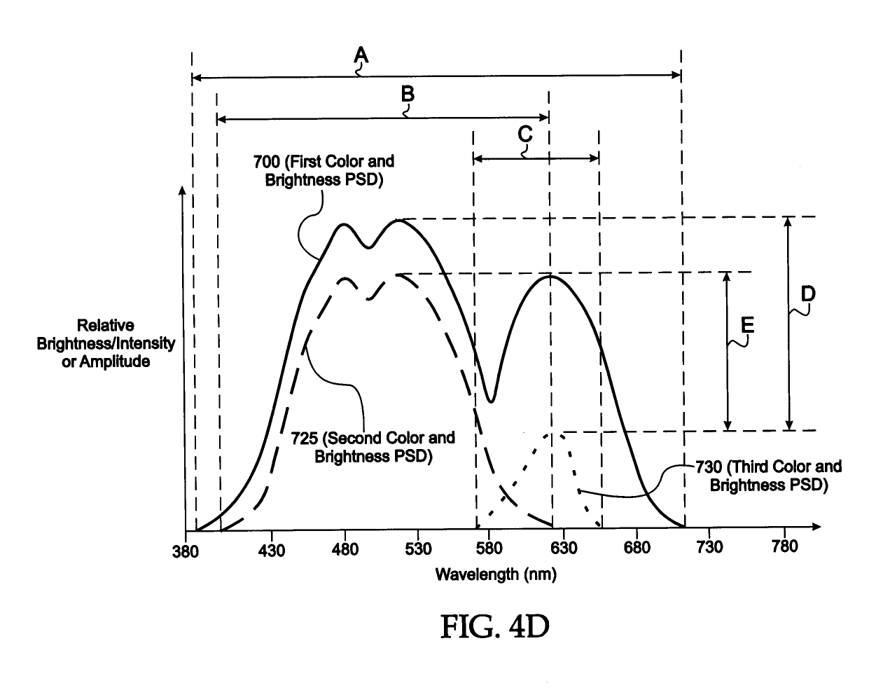

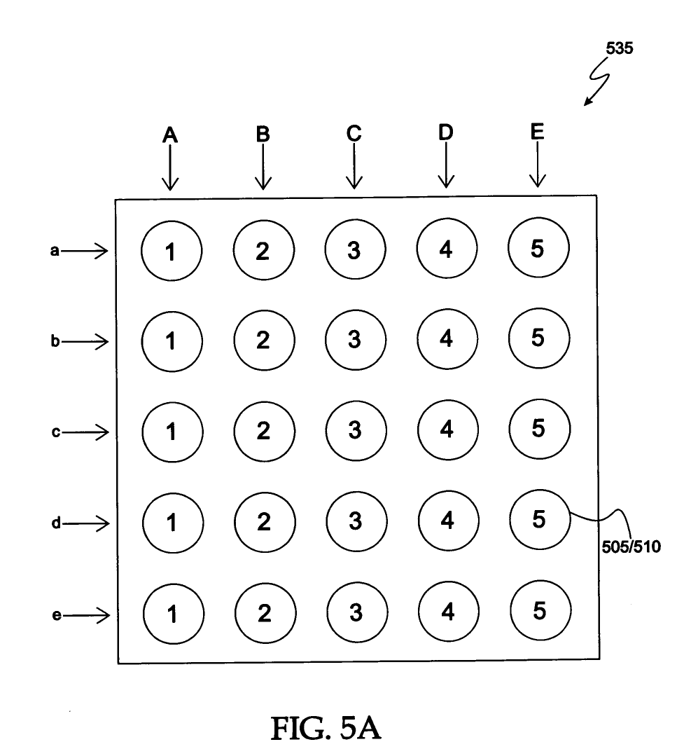

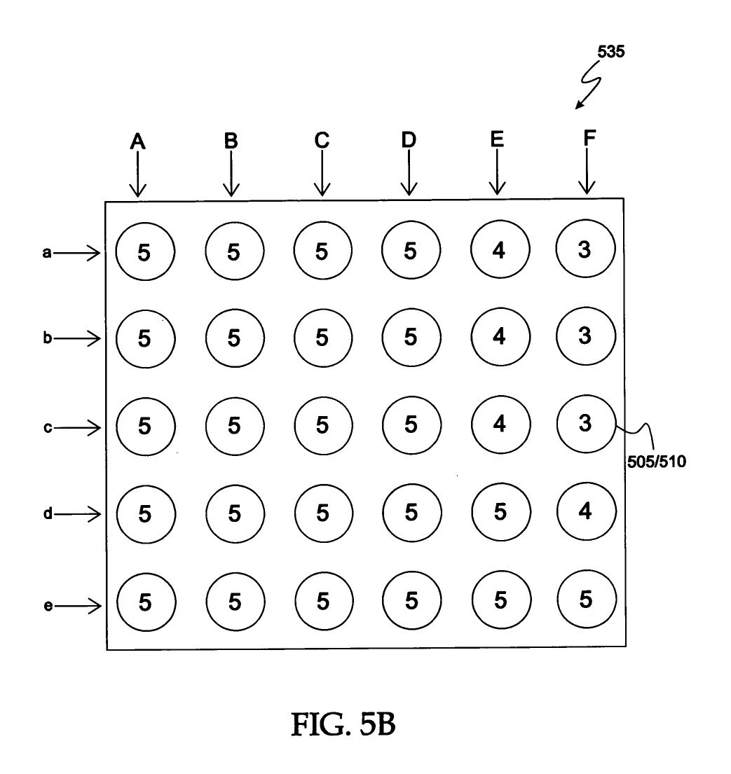

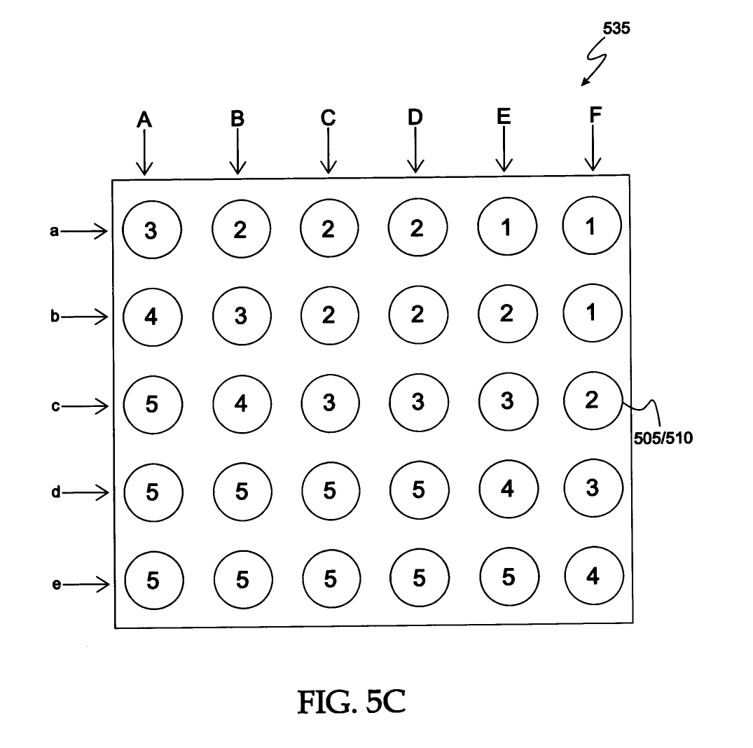

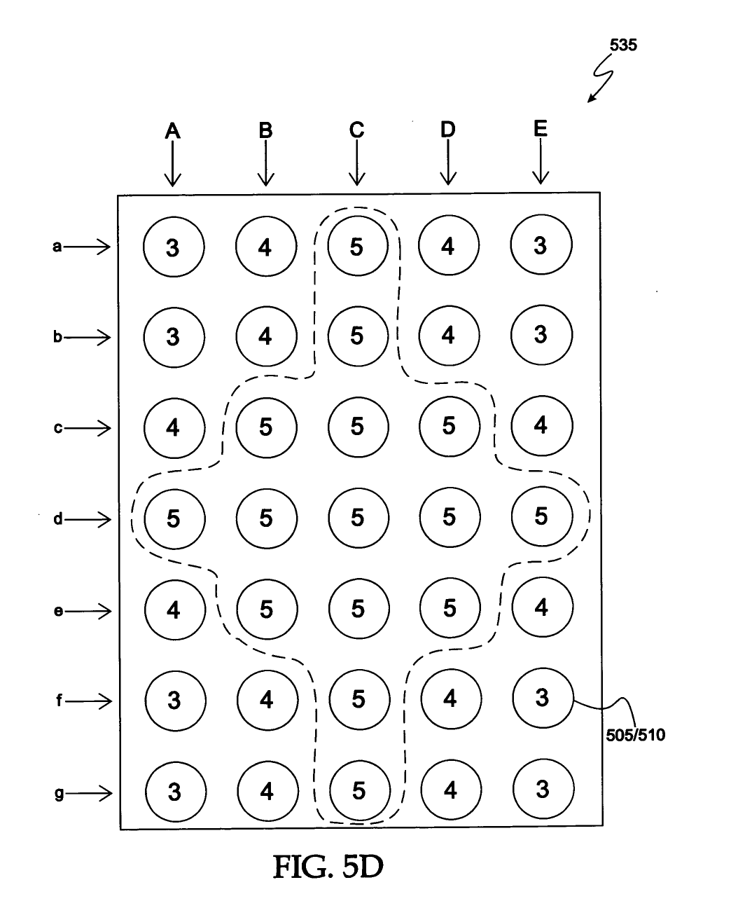

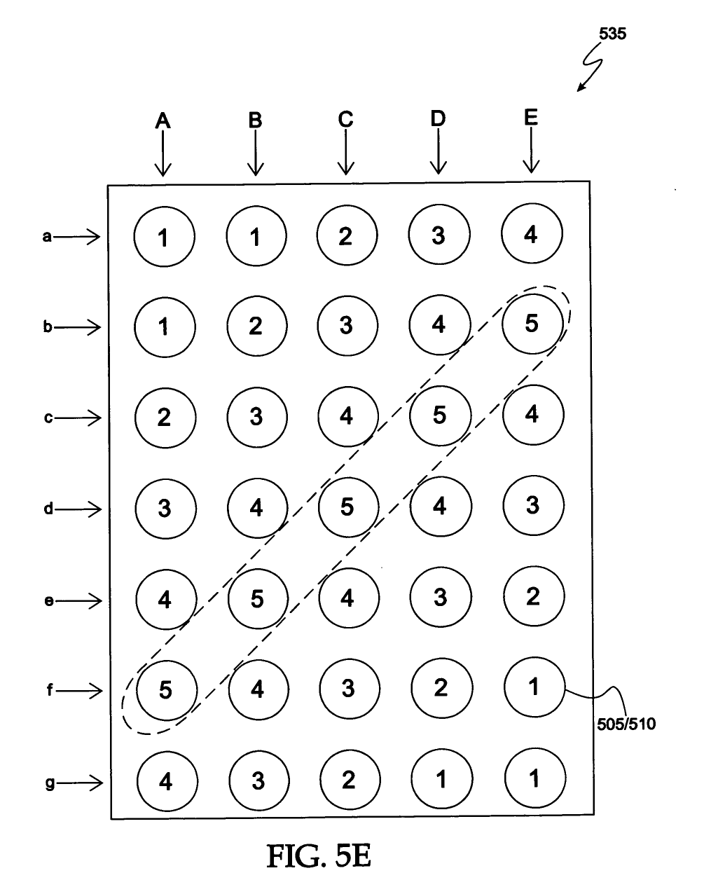

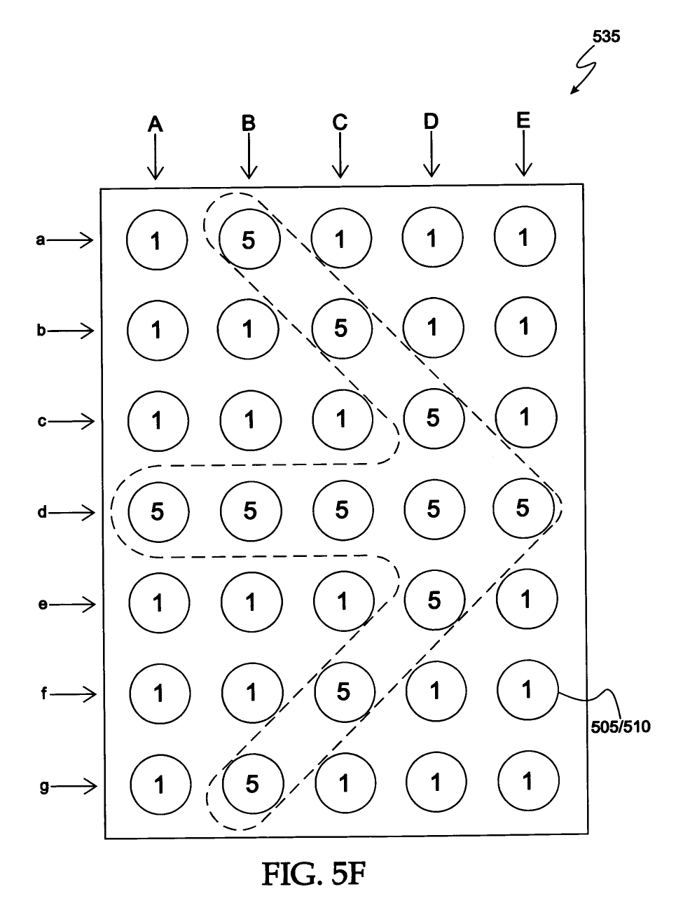

Continuing to refer to FIG. 1a, in one embodiment of the present invention LED control circuit 305 is an LED brightness control circuit (hereafter referred to as “LED brightness control circuit 310”) that is operably coupled to LED light source 500 through LED drive circuit 325. The relative intensity or brightness of, or the relative amplitude of light emitted by, LEDs 505 or groups or clusters of LEDs 510 contained in LED light source 500 is controllably configured by LED brightness control circuit 310. For example, LED light source 500 may comprise an array of LEDs 535, of which the brightness of light emitted thereby may be smoothly, gradually or in a step-wise manner changed spatially across the array, changed time-wise, or changed time-wise and spatially. See, for example, FIG. 4a and FIGS. 5a through 5f hereof, more about which is said below. Thus, rather than simply switching selected light source modules or lamp units 515 on or off, one embodiment of the present invention permits much more sophisticated and smoother control over the light emitted by system 100. That is, LED brightness control circuit 315 may be configured to control the brightness of light emitted by LED light source 500 between a minimum brightness and a maximum brightness, where the minimum brightness may be configured to be greater than zero (as opposed to LED light source 500 simply being turned “off”). Feedback control based on inputs from light sensors 220 positioned near LED light source 500 and/or inputs from environmental sensors 205, or where such inputs serve as inputs to LED control circuit 305 without effecting feedback control, add further brightness control possibilities to the number and types of lighting configurations that may be employed in such an embodiment of the present invention.

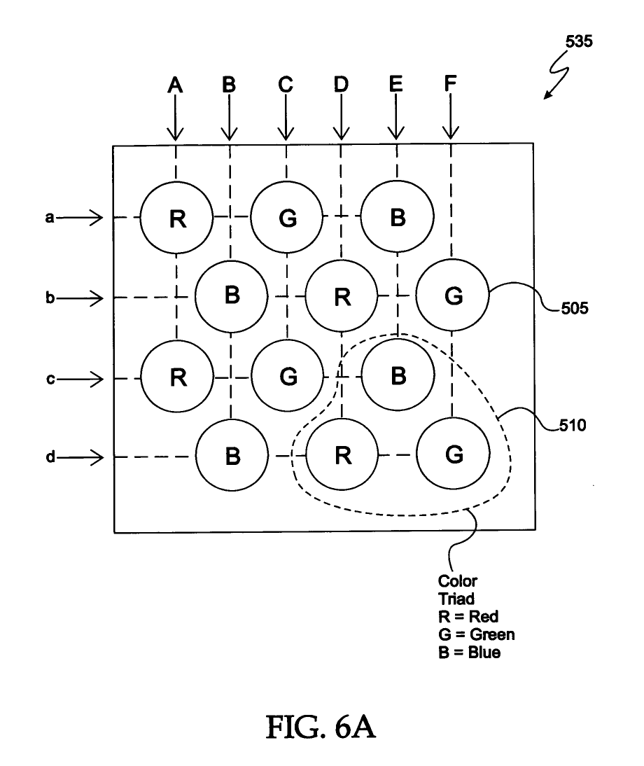

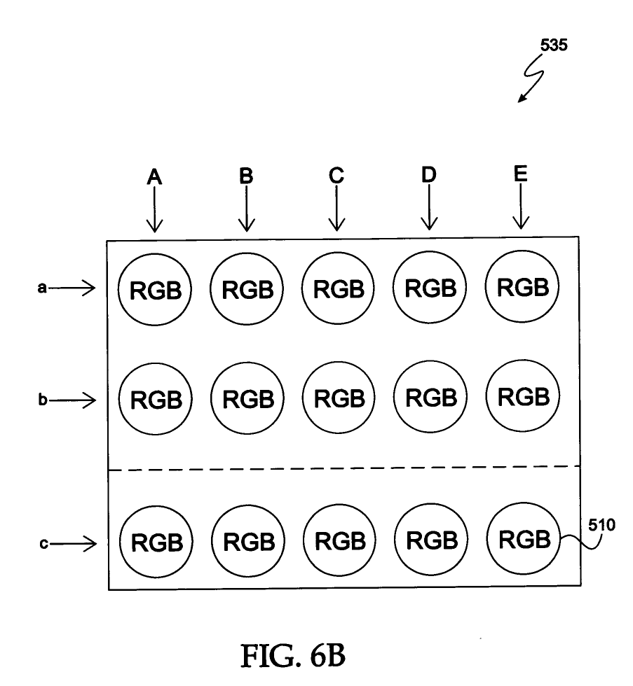

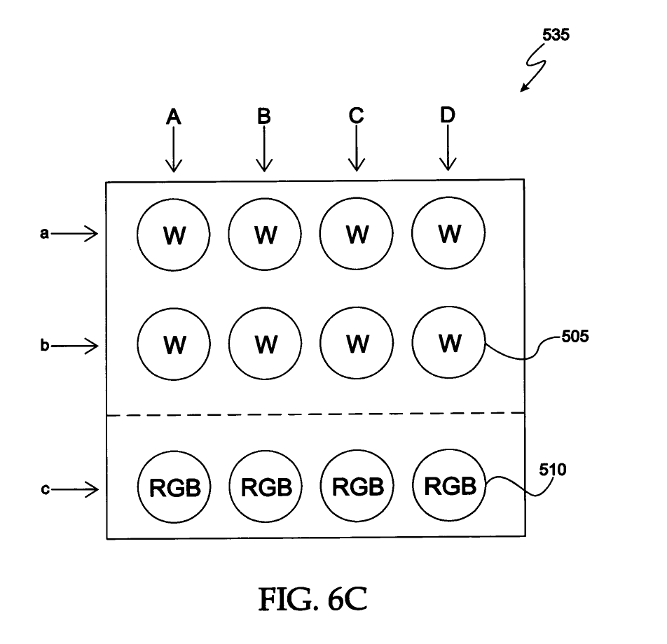

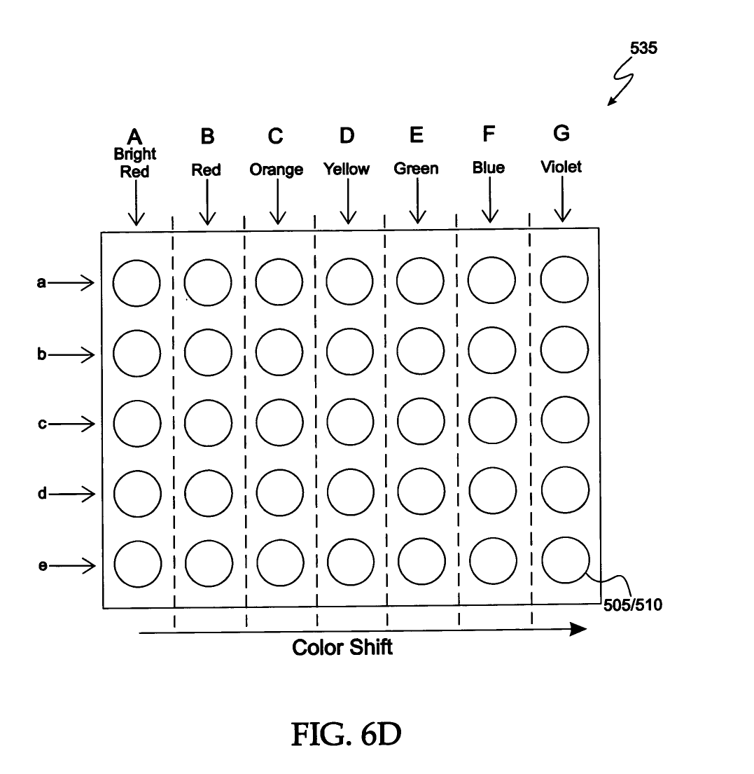

In another embodiment of the present invention, and continuing to refer to FIG. 1a, LED control circuit 305 is an LED color control circuit (hereafter referred to as “LED color control circuit 315”) that is operably coupled to LED light source 500 through LED drive circuit 325. The colors of light emitted by groups or clusters of LEDs 510 contained in LED light source 500 are controllably configured by LED color control circuit 315. For example, LED light source 500 may comprise an array of LEDs 535, of which the color of light emitted thereby may be smoothly, gradually or in a step-wise manner changed spatially across the array, changed time-wise, or changed time-wise and spatially. See, for example, FIG. 4b and FIGS. 6a through 6e hereof, more about which is said below. Thus, rather than simply switching selected light source modules or lamp units 515 of fixed colors on or off, one embodiment of the present invention permits much more sophisticated and smoother control over the colors of light emitted by system 100, as well as permitting a much greater range of colors to be emitted thereby. Feedback control based on inputs from light sensors 220 positioned near LED light source 500 and/or inputs from environmental sensors 205, or where such inputs serve as inputs to LED control circuit 305 without effecting feedback control, add further color control possibilities to the number and types of lighting configurations that may be employed in such an embodiment of the present invention.

In yet another embodiment of the present invention, and continuing to refer to FIG. 1a, LED control circuit 305 is an LED brightness and color control circuit (hereafter referred to as “LED color control circuit 320”) that is operably coupled to LED light source 500 through LED drive circuit 325. The brightness and color of light emitted by groups or clusters of LEDs 510 contained in LED light source 500 are controllably configured by LED color control circuit 320. For example, LED light source 500 may comprise an array of LEDs 535, of which the brightness and color of light emitted thereby may be smoothly, gradually or in a step-wise manner changed spatially across the array, changed time-wise, or changed time-wise and spatially. See, for example, FIGS. 4a and 4b, FIGS. 5a through 5f, and FIGS. 6a through 6e hereof, more about which is said below. Thus, rather than simply switching selected light source modules or lamp units 515 of fixed color or brightness on or off, the present invention permits much more sophisticated and smoother control over the brightness and color of light emitted by system 100, as well as permitting a much greater range of colors to be emitted thereby. Feedback control based on inputs from light sensors 220 positioned near LED light source 500 and/or inputs from environmental sensors 205, or where such inputs serve as inputs to LED control circuit 305 without effecting feedback control, add further brightness and color control possibilities to the number and types of lighting configurations that may be employed in such an embodiment of the present invention.

Any one or more of A/D converter 330, LED control circuit 305 and LED drive circuit 325 may be incorporated into a controller, a micro-controller, a processor, a micro-processor, a processing unit, a CPU, an ASIC, an integrated circuit or a chip.

In respect of LED illumination control and sensor system 200 of the present invention, particular reference is made to the following U.S. Patents assigned to Avago Technologies ECBU IP (Singapore) Pte., Ltd. for detailed information concerning the control and driving, and feedback control, of light emitted by LED light sources: (1) U.S. Pat. No. 6,344,641 to Blalock et al. for “System and method for on-chip calibration of illumination sources for an integrated display,” Feb. 5, 2002; (2) U.S. Pat. No. 6,448,550 to Nishimura for “Method and apparatus for measuring spectral content of LED light source and control thereof,” Sep. 10, 2002; (3) U.S. Pat. No. 6,894,442 to Lim et al. for “Luminary control system,” May 17, 2005; (4) U.S. Pat. No. 7,009,343 to Lim et al. for “System and method for producing white light using LEDs,” Mar. 7, 2006, and (5) U.S. Patent Publication No. 20060054776 to Nishimura for “Method and apparatus for regulating the drive currents of a plurality of light emitters,” Mar. 16, 2006. Each of the foregoing publications is hereby incorporated by reference herein, each in its respective entirety.

The capabilities of the various embodiments of the present invention may be employed to custom-configure the appearance and function of light emitted by LED light source and optical system 400, depending on the particular circumstances under which system 100 is being used. For example, in a case where LED light source and optical system 400 is a headlight or tail light comprising an array of LEDs 535, LED light source 500 may be controllably configured to accent or follow design cues of the automobile in which system 100 has been installed by varying the brightness, the color, or both the brightness and the color of the various LEDs 505 in LED array 535 in accordance with such design cues. The brightness, hue, tint or color of light emitted by system 100 may also be configured to complement or match the paint color of the automobile in which system 100 has been installed.

As external lighting conditions change at dawn, during the day, at dusk or at night, the brightness, hue, tint or color of light emitted by system 100 may be configured using inputs from environmental sensors 205 to provide customized optimal lighting according to the ambient light conditions in existence at the moment, or may be adjusted to complement or match the paint color or physical appearance of the automobile in which system 100 has been installed. System 100 of the present invention may be configured to sense and respond to changing weather or external light conditions and provide emitted light that is tuned or optimized to the particular ambient conditions at hand. As a further example, in response to foggy conditions being detected by environmental sensors 205, system 100 may be adjusted to provide light emitted from headlights that is more yellowish in tint than conventional “white” light. Many other possibilities for changing the brightness, color, or brightness and color of light emitted by system 100 are possible, more about which is said below.

Environmental sensor 205 is configured to sense at least one environmental characteristic and provide one or more inputs based on same to A/D converter 330. As discussed above, such inputs may be employed as part of a feedback control system for controlling and adjusting the brightness, color and/or brightness and color of light emitted by LED light source 500. Environmental sensor 205 may be any one or more of an external lighting level sensor, an automotive cabin lighting level sensor, on-coming headlight sensor, a rain sensor, a water sensor, a mist sensor, a snow sensor, an ice sensor, a sleet sensor, a fog sensor, a road width sensor, a road condition sensor, a road type sensor, an accelerometer, an automotive speed sensor, a pedestrian sensor, an off-axis vehicle sensor, a moving object sensor, an ignition key sensor, a keyless entry remote control sensor, a door sensor, a trunk sensor, an alarm sensor, a proximity sensor, a seatbelt sensor, an accident sensor, and/or any other type of suitable sensor. Multiple input signals of different types may be provided to A/D converter 330 by environmental sensors 205.

Light sensors 220 of the present invention may be photosensors, photodiodes, photodetectors, or any other suitable type of light sensor capable of sensing the brightness and/or color of light emitted by system 100. Light sensors 220 may be positioned in any of a number of different locations within or outside LED light source and optical system 400. For example, in one embodiment of the present invention, light sensors 220 may be disposed on an LED chip or semiconductor 525 between LEDs 505 in a manner similar to that described in the '550 patent to Nishimura. Light sensors 220 may be located anywhere within system 400 or external thereto, so long as sensors 220 are capable of effectively sensing the brightness or color of light emitted by system 100.

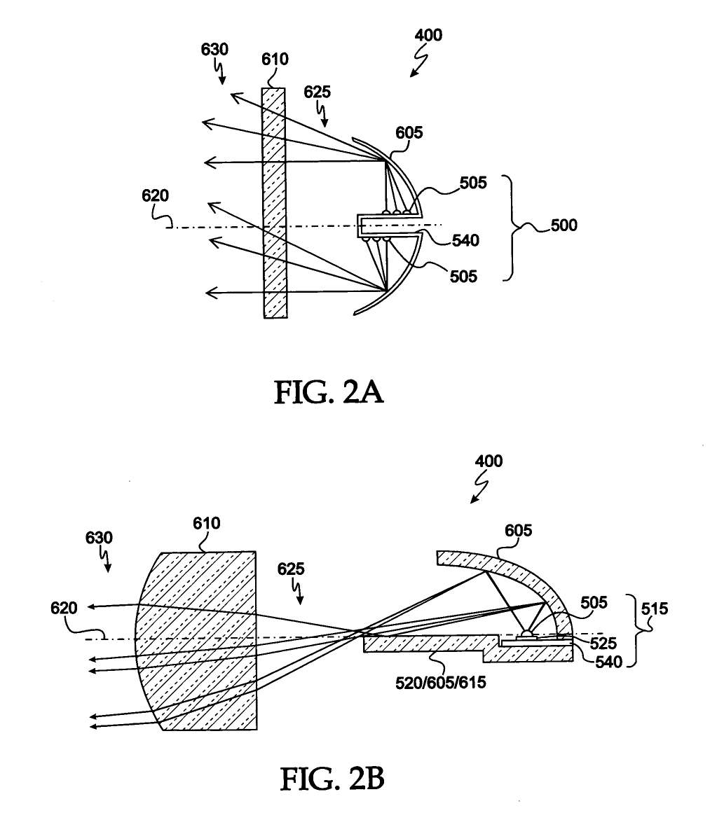

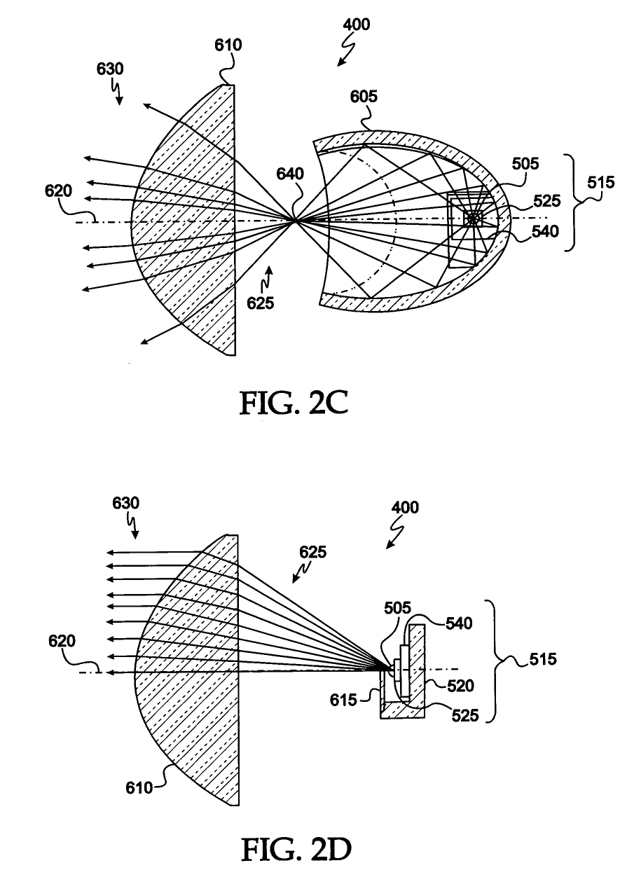

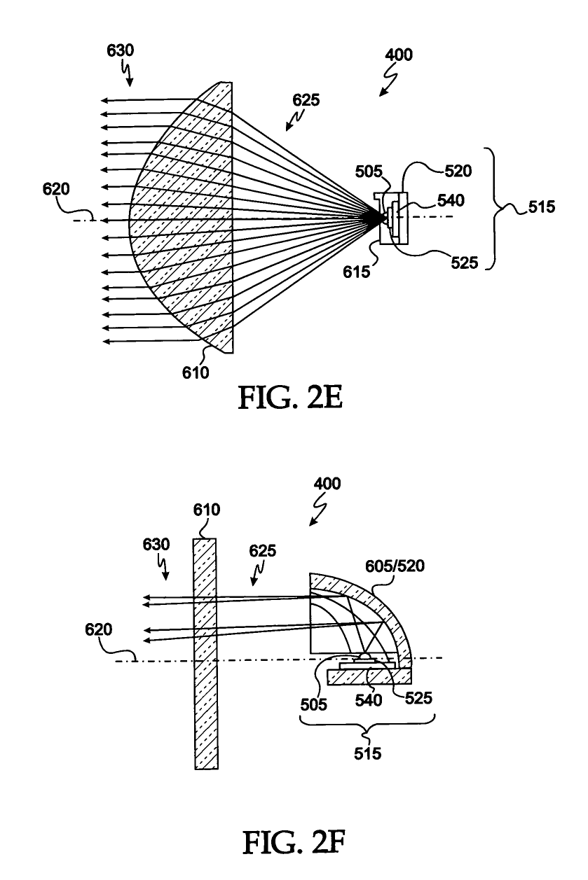

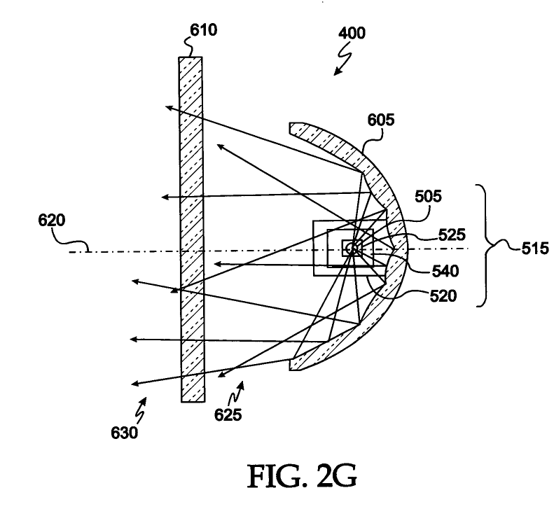

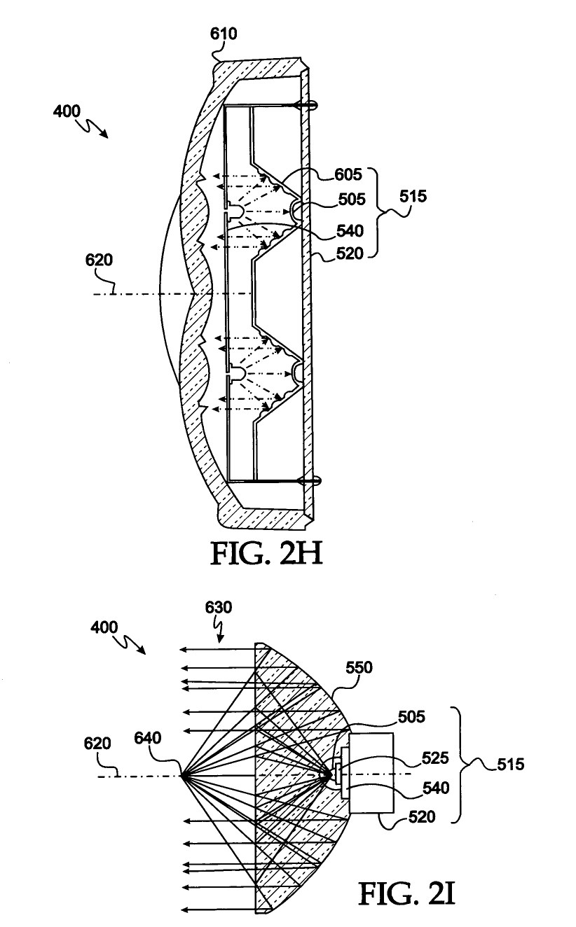

In a preferred embodiment of the present invention, LED light source 500 comprises one or more LED chips or semiconductors 525 such as those described in the foregoing '641, '550, '442 and '343 patents assigned to Avago Technologies. In such embodiments, light source 500 may further comprise fluorescent material disposed adjacent one or more of the LEDs thereof, which material will radiate light in response to having been excited by light emitted from adjacent LEDs. LED light source 500 is not limited to semiconductor embodiments, however, and includes within its scope printed circuit boards containing discrete LEDs mounted thereon, as well as other types of LED light sources presently known in the automotive lighting arts. LED light source 500 may also be attached to, mounted on or form a portion of LED support 540, as shown in FIGS. 2a through 2i.

Referring now to FIG. 1b, further illustrative details concerning one embodiment of LED light source and optical system 400 of the present invention are shown. In FIG. 1b, LED light source and optical system 400 comprises LED light source 500 and optical assembly 600. LED light source 500 of FIG. 1b comprises LED light source modules or lamp units 515a through 515e, each of which may contain one or more LEDs 505, or groups or clusters of LEDs 510. The embodiment of the present invention shown in FIG. 1b is particularly well adapted for the use of LED chips or semiconductors 525a through 525e mounted within LED housings 520a through 520e. Light is emitted outwardly from chips 525a-525e and housings 520a-520e through apertures disposed in the housings for subsequent collimation by lenses 610a through 610e. Collimated light beams 630 result, which are directed in the approximately the same directions as optical axes 620a through 620e. Shade or light blocking element 615 is shown blocking a portion of the light rays 625 emitted from LED housing 520e. Light sensors 220a through 220e are shown as being disposed near the apertures of LED housings 520a through 520e, but may also be mounted on or attached to or near chips 525a-525e. Other locations for light sensors 220 within system 400 are also contemplated in the present invention, as discussed above.

As is described in further detail below in connection with FIGS. 2a through 2i, optical assembly 600 may include one or more of reflectors 605, lenses 610, and other optical elements 615. Reflector(s) 605 may comprise any one or more of a parabolic reflector, an elliptical reflector, a spherical reflector, a spheroidal reflector, an oblate reflector, an oblate spheroidal reflector, a chamfered reflector, and/or a reflective surface. Lens(es) 610 may comprise any one or more of a projection lens, a condenser lens, a concave lens, a convex lens, a planar lens, a plano-concave lens, a piano-convex lens, a translucent lens, a light-guiding lens, an LED lens, an internally-reflecting lens, a fresnel lens, and an optical or color mixer. Other optical elements 615 may comprise any one or more of a shade, a diffuser, a screen, a secondary reflector, a retro-reflector, a light guide, and an optical manifold.

FIGS. 2a through 2i illustrate various different embodiment of some of the LED light source and optical systems 400 of the present invention. As will become apparent by referring to the embodiments of the present invention illustrated in FIGS. 2a through 2i and described in further detail hereinbelow, distinctions between LED light source 500, LED light module or lamp unit 515, LEDs 505, groups or clusters of LEDs 510, LED housings 520, optical systems 600, reflectors 605, lenses 610 and other light elements 615 may become blurred or indistinct as the various components structurally and optically cooperate with one another to orient, house and support LED light generating and emitting means, and to direct the light emitted thereby into a collimated beam. As will also become apparent by referring to the embodiments of the present invention illustrated in FIGS. 2a through 2i and described in further detail hereinbelow, not all the foregoing elements need be present to form an effective LED light source 500 and optical system 400 of the present invention. Moreover, and still referring to FIGS. 2a through 2i, note that groups or clusters of LEDs 510 may be substituted for LEDs 505 illustrated in any of such figures.

FIG. 2a shows one system 400 where LED light source 500 comprises individual LEDs 505 mounted on LED support 540. Light rays 625 emitted by LEDs 505 are reflected by reflector 605 through lens 610 to form collimated light beams 630 which are directed approximately along optical axis 620.

FIG. 2b shows another system 400 where LED light source 500 comprises LED chip 525 mounted on LED support 540. Light rays 625 emitted by LED chip 525 are reflected by reflector 605 through lens 610 to form collimated light beams 630 which are directed approximately along optical axis 620. LED light source or lamp unit 515 comprises LEDs 505, LED chip 525 and LED support 540, which is mounted on LED housing 520. As shown in FIG. 2b, portions of LED housing 520 act as a reflector 605 and a shade 615.

FIG. 2c shows a system 400 where LED light source 500 comprises LED chip 525 mounted on LED support 540. Light rays 625 emitted by LED chip 525 are reflected by reflector 605 through lens 610 to form collimated light beams 630 which are directed approximately along optical axis 620. LED light source or lamp unit 515 comprises LEDs 505, LED chip 525 and LED support 540.

FIG. 2d shows another system 400 where LED light source 500 comprises LED chip 525 mounted on LED support 540, which in turn is attached to LED housing 520. Portions of light rays 625 emitted by LED chip 525 are blocked by shade 615, which forms a portion of LED housing 520. Light rays 625 not blocked by shade 615 are directed through lens 610 to form collimated light beams 630 which are directed approximately along optical axis 620.

FIG. 2e shows one system 400 similar to that illustrated in FIG. 1b, where LED light source 500 comprises LED chip 525 mounted on LED support 540, which in turn is attached to LED housing 520, and where an aperture located forward from LED 505 constricts the angles through which light rays 625 may propagate. Portions of light rays 625 emitted by LED chip 525 are blocked by shade/aperture 615, which forms a portion of LED housing 520. Light rays 625 not blocked by shade/aperture 615 are directed through lens 610 to form collimated light beams 630 which are directed approximately along optical axis 620.

FIG. 2f shows a system 400 where LED light source 500 again comprises LED chip 525 mounted on LED support 540. Light rays 625 emitted by LED chip 525 are reflected by reflector 605 through lens 610 to form collimated light beams 630 which are directed approximately along optical axis 620. LED light source or lamp unit 515 comprises LEDs 505, LED chip 525 and LED support 540, which is mounted on LED housing 520/reflector 605. As shown in FIG. 2f, portions of LED housing 520 act as a reflector 605.

FIG. 2g shows another system 400 where LED light source 500 comprises LED chip 525 mounted on LED support 540 and LED housing 520. Light rays 625 emitted by LED chip 525 are reflected by reflector 605 through lens 610 to form collimated light beams 630 which are directed approximately along optical axis 620. LED light source or lamp unit 515 comprises LEDs 505, LED chip 525, LED support 540 and LED housing 520.

FIG. 2h shows one system 400 where LED light source 500 comprises LED 505 mounted on LED support 540. Light rays 625 emitted backwardly from LED 505 are reflected forwardly by reflector 605 through lens 610 to form collimated light beams 630 which are directed approximately along optical axis 620. LED light source or lamp unit 515 comprises LEDs 505, LED support 540 and LED housing 520.

FIG. 2i shows another system 400 where LED light source 500 comprises LED chip 525 mounted on LED support 540. Light rays 625 emitted by LED chip 525 are captured by surrounding LED lens or translucent member 550 and collimated forwardly to create collimated light beams 630, which are directed approximately along optical axis 620. LED light source or lamp unit 515 comprises LEDs 505, LED chip 525, LED support 540, and LED housing 520. Note that no reflector 605 is necessarily required in the embodiment of the present invention illustrated in FIG. 2i.

In some embodiments of the present invention, the use of LEDs capable of emitting light of different colors is contemplated. Table 1 below lists some of the more commonly available colors of LEDs which may be employed in the present invention. FIG. 3a shows light wavelength spectra corresponding to some of the LEDs listed in Table 1. FIG. 3b shows a CIE chromaticity diagram, where pure spectral colors are located along the perimeter of the demarcated boundaries of the chromaticity area. All other colors are located inside the perimeter. The chromaticity coordinates for some standard light sources are as follows:

| Source | x | y |
|---|---|---|
| Fluorescent lamp 4800 deg. K | 0.35 | 0.37 |
| Sun 6000 deg. K | 0.32 | 0.33 |
| Red Phosphor (europium yttrium | 0.68 | 0.32 |
| vanadate) | | |

| | | |
|---|---|---|
| Green Phosphor (zinc cadmium sulfide) | 0.28 | 0.60 |
| Blue Phosphor (zinc sulfide) | 0.15 | 0.07 |

Light emitted by LEDs of different color, and their corresponding individual intensities or brightnesses, may be modulated by means of LED control circuit 305, LED drive circuit 325 and/or optical system 400 to produce collimated light beams 635 having many, if not most, of the colors illustrated in the CIE chromaticity diagram of FIG. 3a. LED light source 500 may comprise white LEDs, phosphor-converted white LED, LEDs of other colors (such as those shown in Table 1 below), or one or more clusters of LEDs comprising at least one LED of a first color and at least one LED of a second color, where the first color is different from the second color. The relative brightnesses of the first and second color LEDs may be modulated by LED control circuit 305 and LED drive circuit 325 to effect changes in the color of the combined light emitted by the first and second LEDs.

In a preferred embodiment of the present invention, light source 500 comprises one or more clusters of LEDs having three different colors, such as red, green and blue, to permit finer modulation and better control of the combined colors emitted by LED clusters 510 comprising three LEDs. More than three LEDs may also be employed in LED clusters or groups 510 of the present invention, depending on the particular application at hand. For example, if a single LED 505 of a first color emits less light relative to an LED 505 of a second or third color, more than one LED 505 of the first color may be employed in a cluster of LEDs 510 comprising LEDs 505 of the first, second and third colors. Or an LED 505 of a fourth color may be added to an LED cluster 510 comprising LEDs 505 of first, second and third colors to fill in a gap in, or low-amplitude portion of, the combined light spectrum emitted by the LEDs 505 of the first, second and third colors.

TABLE 1
LED Color Chart

| Wavelength | | Fwd Voltage | Intensity | Viewing | |
|---|---|---|---|---|---|
| (nm) | Color Name | (Vf @ 20 ma) | 5 mm LEDs | Angle | LED Dye Material |
| 940 | Infrared | 1.5 | 16 mW | 15° | GaAIAs/GaAs—Gallium |
| | | | @50 mA | | Aluminum Arsenide/Gallium |
| | | | | | Arsenide |
| 880 | Infrared | 1.7 | 18 mW | 15° | GaAIAs/GaAs—Gallium |
| | | | @50 mA | | Aluminum Arsenide/Gallium |
| | | | | | Arsenide |
| 850 | Infrared | 1.7 | 26 mW | 15° | GaAIAs/GaAs—Gallium |
| | | | @50 mA | | Aluminum Arsenide/Gallium |
| | | | | | Aluminum Arsenide |
| 660 | Ultra Red | 1.8 | 2000 mcd | 15° | GaAIAs/GaAs—Gallium |
| | | | @50 mA | | Aluminum Arsenide/Gallium |
| | | | | | Aluminum Arsenide |
| 635 | High Eff. Red | 2.0 | 200 mcd @20 mA | 15° | GaAsP/GaP—Gallium Arsenic |
| | | | | | Phosphide/Gallium |
| | | | | | Phosphide |
| 633 | Super Red | 2.2 | 3500 mcd | 15° | InGaAIP—Indium Gallium |
| | | | @20 mA | | Aluminum Phosphide |
| 620 | Super Orange | 2.2 | 4500 mcd | 15° | InGaAIP—Indium Gallium |
| | | | @20 mA | | Aluminum Phosphide |
| 612 | Super | 2.2 | 6500 mcd | 15° | InGaAIP—Indium Gallium |
| | Orange | | @20 mA | | Aluminum Phosphide |
| 605 | Orange | 2.1 | 160 mcd @20 mA | 15° | GaAsP/GaP—Gallium Arsenic |
| | | | | | Phosphide/Gallium |
| | | | | | Phosphide |
| 595 | Super Yellow | 2.2 | 5500 mcd | 15° | InGaAIP—Indium Gallium |
| | | | @20 mA | | Aluminum Phosphide |
| 592 | Super Pure | 2.1 | 7000 mcd | 15° | InGaAIP—Indium Gallium |
| | Yellow | | @20 mA | | Aluminum Phosphide |
| 585 | Yellow | 2.1 | 100 mcd @20 mA | 15° | GaAsP/GaP—Gallium Arsenic |
| | | | | | Phosphide/Gallium |
| | | | | | Phosphide |
| 4500K | “Incandescent” | 3.6 | 2000 mcd | 20° | SiC/GaN—Silicon |
| | White | | @20 mA | | Carbide/Gallium Nitride |
| 6500K | Pale | 3.6 | 4000 mcd | 20° | SiC/GaN—Silicon |
| | White | | @20 mA | | Carbide/Gallium Nitride |
| 8000K | Cool White | 3.6 | 6000 mcd | 20° | SiC/GaN—Silicon Carbide/ |
| | | | @20 mA | | Gallium Nitride |
| 574 | Super | 2.4 | 1000 mcd | 15° | InGaAIP—Indium Gallium |
| | Lime Yellow | | @20 mA | | Aluminum Phosphide |
| 570 | Super | 2.0 | 1000 mcd | 15° | InGaAIP—Indium Gallium |
| | Lime Green | | @20 mA | | Aluminum Phosphide |
| 565 | High | 2.1 | 200 mcd | 15° | GaP/GaP—Gallium |
| | Efficiency | | @20 mA | | Phosphide/Gallium Phosphide |
| | Green | | | | |
| 560 | Super | 2.1 | 350 mcd | 15° | InGaAIP—Indium Gallium |
| | Pure Green | | @20 mA | | Aluminum Phosphide |
| 555 | Pure Green | 2.1 | 80 mcd | 15° | GaP/GaP—Gallium Phosphide/ |
| | | | @20 mA | | Gallium Phosphide |
| 525 | Aqua Green | 3.5 | 10,000 mcd | 15° | SiC/GaN—Silicon Carbide/ |
| | | | @20 mA | | Gallium Nitride |
| 505 | Blue Green | 3.5 | 2000 mcd | 45° | SiC/GaN—Silicon Carbide/ |
| | | | @20 mA | | Gallium Nitride |
| 470 | Super Blue | 3.6 | 3000 mcd | 15° | SiC/GaN—Silicon Carbide/ |
| | | | @20 mA | | Gallium Nitride |
| 430 | Ultra Blue | 3.8 | 100 mcd | 15° | SiC/GaN—Silicon Carbide/ |
| | | | @20 mA | | Gallium Nitride |

Referring now to FIG. 4a, there are shown standard power spectral distributions corresponding to blue, green and red LEDs. There is also shown a power spectral distribution resulting from the combination of the light emitted by the blue, green and red LEDs, which is labeled in FIG. 4a as “Combined PSD 700”, where PSD denotes “Power Spectral Distribution.”

FIG. 4b shows PSD 700 labeled as a “First Brightness Level,” and two other curves labeled 705 (“Second Brightness Level”) and 710 (“Third Brightness Level”). The three brightness levels of FIG. 4b illustrate how relative brightness or intensity settings may be achieved and modulated using LED brightness control circuit 310 and LED drive control circuit 325 of the present invention. The relative amplitudes of combined or mixed light emitted by the three LEDs of different color may be controlled or modulated smoothly and virtually continuously, for example, between first brightness level 700 and third brightness level 710 in FIG. 4b by means of LED brightness control circuit 310 and LED drive circuit 325 of the present invention.

Reference to FIG. 4b shows that relative bandwidths A, B and C of PSDs 700, 705 and 710 differ from one another, and thus the color of light emitted by system 100 changes as brightness is increased or decreased. It is therefore further contemplated in the present invention that LED brightness control circuit 310 and/or LED drive circuit 325 may include digital signal processing means for adjusting the relative bandwidths or carrying out spectral whitening in respect of PSDs 700, 705 and 710 so that the color of light emitted by system 100 may remain relatively constant as brightness levels are modulated.

FIG. 4c shows PSD 700 labeled as a “First Color PSD,” and two other curves labeled 715 (“Second Color PSD”) and 720 (“Third Color PSD”). The three PSDs shown in FIG. 4c correspond to light of different colors emitted by system 100 of the present invention. Note that PSDs 715 and 720 are wavelength-shifted to the right in respect of PSD 700, and are also characterized by narrower bandwidths than PSD 700. Accordingly, light emitted by system 100 of the present invention in accordance with PSD 700 appears more white in hue to a human observer than does light characterized by the second PSD 715 or third PSD 720 (which appear more green and red, respectively, to a human observer). PSDs 700, 715 and 720 shown in FIG. 4c illustrate how relative color settings may be achieved and modulated using LED color control circuit 315 and LED drive control circuit 325 of the present invention. The relative colors of combined or mixed light emitted by the three LEDs of different color may be controlled or modulated smoothly and virtually continuously, for example, between first color PSD 700 and third color PSD 720 in FIG. 4c by means of LED color control circuit 310 and LED drive circuit 325 of the present invention.

Reference to FIG. 4c shows that relative bandwidths A, B and C of PSDs 700, 715 and 720 differ from one another, and thus the brightness of light emitted by system 100 changes as color changes. It is therefore further contemplated in the present is invention that LED color control circuit 315 and/or LED drive circuit 325 may include digital signal processing means for adjusting the relative bandwidths or carrying out spectral whitening of PSDs 700, 705 and 710 so that the brightness of light emitted by system 100 may remain relatively constant as the colors of light emitted by system 100 are changed.

FIG. 4d shows PSD 700 labeled as a “First Color and Brightness Level,” and two other curves labeled 725 (“Second Color and Brightness Level”) and 730 (“Third Color and Brightness Level”). The three color and brightness levels of FIG. 4d illustrate how relative brightness or intensity levels and color changes may be achieved and modulated using LED brightness and color control circuit 320 and LED drive control circuit 325 of the present invention. The relative amplitudes and power spectral distributions of combined or mixed light emitted by the three LEDs of different color may be controlled or modulated smoothly and virtually continuously, for example, between first color and brightness level 700 and third color and brightness level 730 of FIG. 4d by means of LED brightness and color control circuit 320 and LED drive circuit 325 of the present invention. Accordingly, relative bandwidths A, B and C of PSDs 700, 725 and 730 are wavelength-shifted to longer wavelengths respecting one another. The relative amplitudes of PSDs 700, 725 also differ, as shown by PSD amplitude difference D (between PSD 700 and PSD 730), and PSD amplitude difference E (between PSD 725 and PSD 730). In the present invention, LED color and brightness control circuit 320 and/or LED drive circuit 325 may therefore include digital signal processing means for adjusting the relative bandwidths or carrying out spectral whitening in respect of PSDs 700, 725 and 730 so that the colors and brightness of light emitted by system 100 may be more controllably modulated.

FIGS. 5a through 5f illustrate various types of outputs that may be achieved using LED brightness control circuit 310 and LED drive circuit 325 of the present invention. For purposes of clarity, note that components of optical system 600 such as reflectors 605, lenses 610 or other optical elements 615 are not shown in FIGS. 5a through 5f. It is to be understood, however, that a complete and functionally operative automotive illumination system 100 of the present invention should include one or more such components, usually in conjunction with each LED light source or lamp unit 515 or a group of LED light sources or lamp units 515.

FIG. 5a shows one embodiment of a brightness-controllable automotive illumination device of the present invention. In FIG. 5a, rows a though e, and columns A through E, of LED array 535 comprise LEDs 505, or clusters or groups of LEDs 510, disposed at each row-column intersection. LEDs 505 or clusters of LEDs 510 in column A operate at a brightness level of “1,” under the control of LED brightness control circuit 310, while LEDs 505 or clusters of LEDs 510 in column E operate at a higher brightness level of “5” under the control of 310. Brightness levels of columns B through D located between columns A and E vary smoothly between the illustrated minimum and maximum brightness levels. The result is an automotive illumination system emitting collimated light beams 630 which vary in brightness spatially across array 535 to form a predetermined brightness pattern. As mentioned above, LED array 535 may also be configured such that LEDs 505 or clusters of LEDs 510 operate at brightness levels which vary in respect of time, or in respect of space and time.

FIGS. 5b and 5c illustrate the operation of one embodiment of a headlight of the present invention. FIG. 5b shows a first state of system 100 corresponding to a high beam headlight. FIG. 5c shows a second state of system 100 corresponding to a low beam headlight. In FIGS. 5b and 5c, LEDs/LED clusters 505/510 on the right side of LED 535 array are positioned closer to the center of a road and on-coming traffic than are LEDs/LED clusters 505/510 located on the left side of LED 535 array. Consequently, and as indicated by brightness level numerals 1 through 5 in FIGS. 5b and 5c, the brightness of LEDs/LED clusters 505/510 increases from right to left across LED array 535.

When the headlight of system 100 is in the first state shown in FIG. 5b, most LEDs/LED clusters 505/510 operate at maximum brightness level 5, with brightness levels dropping off towards the right side of LED array 535 (or towards the center of the road). Brightness levels also decrease towards the upper right-hand corner of LED array 535, where upper rows a and b comprise LEDs/LED clusters that emit light that is collimated more forwardly and further down the roadway than is light emitted by LEDs/LED clusters 505/510 in lower rows d and e, which is collimated more downwardly and nearer the automobile.

When the headlight of system 100 is in the second state shown in FIG. 5c, LEDs/LED clusters 505/510 in the upper rows operate at lower brightness levels 1 through 4. Brightness levels drop off towards the right side and the upper right hand corner of LED array 535 (or towards the center of the road). Consequently, in a low beam mode, the brightness of LEDs/LED clusters 505/510 in the upper rows is decreased dramatically, while the brightness of LEDs/LED clusters 505/510 in the lower rows remains relatively unchanged owing to differences in the directions in which light is collimated by differing optical systems 600 of the upper and lower rows, and the right and left sides of array 535. As shown in FIGS. 5b and 5c, LED brightness control circuit and LED drive circuit 325 of the present invention permit sophisticated control to be exercised over the brightness and collimation of light emitted by different portions of system 100 in respect of time and space.

Referring now to FIGS. 5d and 5e, there are shown two examples of LED arrays 535 displaying spatially-varying brightness levels. In the example of FIG. 5d, LEDs/LED clusters 505/510 located towards the center of array 535 have the highest brightness levels. In the example of FIG. 5e, LEDs/LED clusters 505/510 located along an upper right to lower left diagonal have the highest brightness levels. Such spatial variations in brightness levels may be employed to accent or follow design cues on an automobile, or to change according to the color or model of an automobile, one or more predetermined time schedules, external light levels, or any other suitable variable.

Referring now to FIG. 5f, there is shown an example of a turn signal configuration of a tail light of the present invention. In a normal operating mode (i.e., non-turning mode), one embodiment of a tail light of the present invention displays the brightness pattern of FIG. 5d or FIG. 5e. When the turn signal is activated, the brightness pattern shown in FIG. 5f is displayed and alternates with that shown in FIG. 5d or FIG. 5e under the control of LED brightness control circuit 510 and LED drive circuit 525 of the present invention. Of course, many brightness patterns other than those shown in the Figures are contemplated in the present invention.

FIGS. 6a through 6e illustrate various types of outputs that may be achieved using LED color control circuit 315 and LED drive circuit 325 of the present invention. For purposes of clarity, note that components of optical system 600 such as reflectors 605, lenses 610 or other optical elements 615 are not shown in FIGS. 6a through 6e. It is to be understood, however, that a complete and functionally operative automotive illumination system 100 of the present invention should include one or more such components, usually in conjunction with each LED light source or lamp unit 515 or a group of LED light sources or lamp units 515.

FIG. 6a shows one embodiment of a color-controllable automotive illumination device of the present invention. In FIG. 6a, rows a though d, and columns A through F, of LED array 535 comprise individual LEDs 505 of the colors red (R), green (G) and blue (B). Clusters or groups of LEDs 510 emit combined light of a selected color under the control of LED color control circuit 315 and LED drive circuit 325. The relative brightnesses or intensities of LEDs in a color triad group 510 are modulated and controlled by circuits 315 and 325 to produce a desired combined light output or color. The result is an automotive illumination system emitting collimated light beams 630 which vary in color spatially across array 535. LED array 535 may also be configured such that LEDs 505 or LED triads 510 produce colors which vary in respect of time, or in respect of space and time.

FIG. 6b shows another embodiment of a color-controllable automotive illumination device of the present invention. In a first state, color triads 510 in rows a through c are brightness- and color-modulated to operate as a high beam headlight. In a second state, color triads 510 in rows a through c are brightness- and color-modulated to operate as a low beam headlight, or a low-beam headlight and a fog light. Alternatively, in a first state color triads 510 in rows a through c are brightness- and color-modulated to operate as a headlight, and in a second state, color triads 510 in rows a and b are brightness- and color-modulated to operate as a headlight, and color triads 510 in row c are brightness- and color-modulated to operate as a turn signal or running light. As will now become apparent, many other combinations of color-controllable headlights, daytime modulators, turn signals, tail lights, brake lights, running lights, fog lights and backup lights may also be employed in the present invention.

FIG. 6d shows another embodiment of a color-controllable automotive illumination device of the present invention. LEDs/LED clusters 505/510 located at the intersections of rows a though e and columns A through G are preferably color triads 510. As illustrated in FIG. 6d, color triads located in column A are controllably configured by LED color control circuit 315 and LED drive circuit 325 to produce bright red light. Other color triads in columns B through G are controllably configured to produce red, orange, yellow, green, blue and violet light, respectively. In the example of FIG. 6d, light of ever-decreasing wavelength is emitted by LED array 535 as one progresses from left to right across array 535. LED color control circuit 315 and LED drive circuit 325 may be configured to vary the color of light emitted by LED array 535 smoothly or in step-wise fashion according to any desired pattern or combination of hues and colors.

The various brightness and color patterns and concepts illustrated in FIGS. 5a through 6d may be combined in any desired fashion using LED brightness and color control circuit 320 and LED drive circuit 325 of the present invention. Accordingly, the brightness and color of light emitted by LED array 535 may be controlled and modulated by circuits 320 and 325 to produce a virtually infinite number of spatially-varying, time-varying and time- and space-varying brightness and color patterns in the automotive illuminations devices and systems of the present invention.

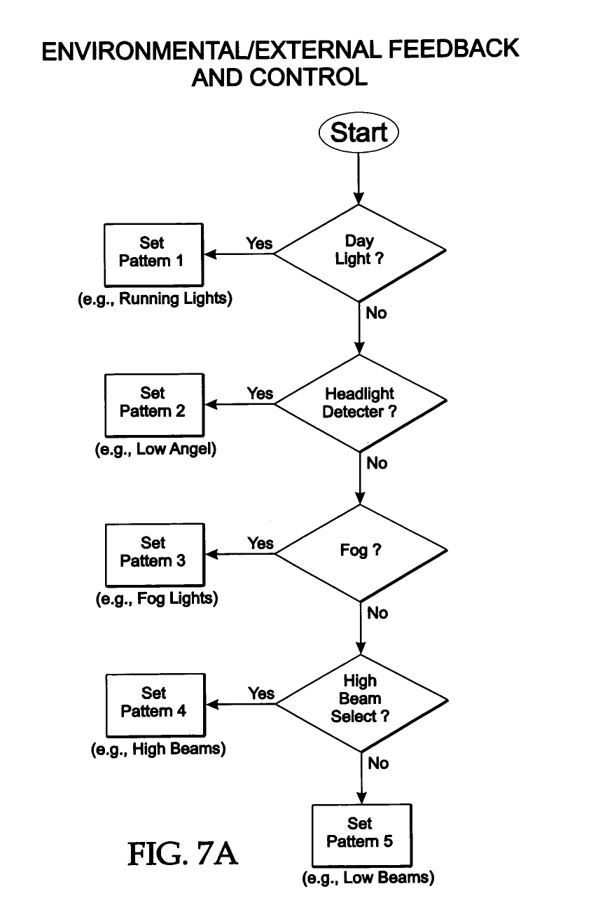

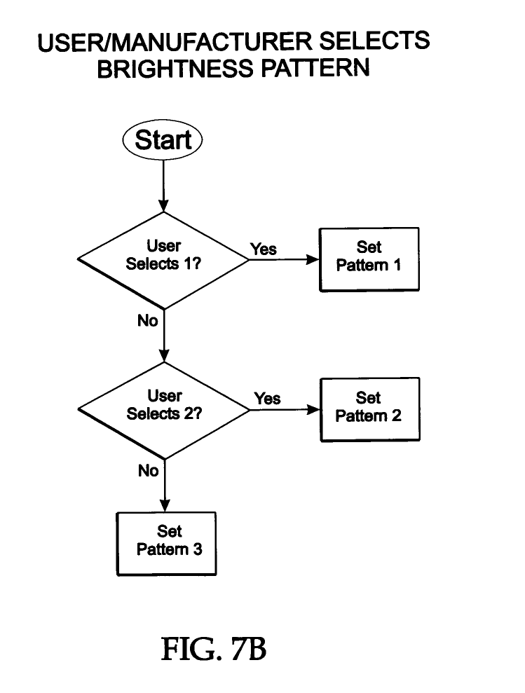

FIG. 7a illustrates one embodiment of a method of controlling and modulating light emitted by an automotive illumination system 100 of the present invention. Environmental sensors 205 provide input signals to LED control circuit 305, which are then employed to adjust the light emitted by LED light source and optical system 400. In the example of FIG. 7a, various illumination patterns are selected by circuit 305 on the basis of external lighting conditions, whether an on-coming set of headlights has been detected, fog has been detected, or whether high beam headlights may be safely employed.

FIG. 7b illustrates another embodiment of a method of controlling and modulating light emitted by an automotive illumination system 100 of the present invention. A user selects between predetermined brightness, color, and/or color and brightness patterns that are to be employed in system 100 of the present invention.

Other embodiments of the present invention include an integrated circuit for an automotive illumination system, comprising an LED brightness control circuit configured to control the brightness of light emitted by LED light sources between at least one minimum brightness level and at least one maximum brightness level, where the at least one minimum brightness level may be configured to be greater than zero. The integrated circuit may further comprise at least one signal input means corresponding to the output of a light sensor, the integrated circuit, the at least one signal input means and the light sensor output comprising a feedback control system for controlling and adjusting the brightness of light emitted by the LED light sources. The at least one signal input may be provided by an analog-to-digital converter forming a portion of the integrated circuit. The integrated circuit may further comprise an LED drive circuit for driving LED light sources.

The present invention includes within its scope various methods of controlling the brightness, the color, and the brightness and the color of light emitted by an automotive illumination system, methods of adjusting the brightness, color and brightness and color of light emitted by an automotive feedback control illumination system, methods of making automotive illumination systems, methods of making automotive feedback control illumination systems, methods of installing automotive illumination systems, methods of installing automotive feedback control illumination systems, and methods of making automobiles.

The preceding specific embodiments are illustrative of the practice of the invention. It is to be understood, therefore, that other expedients known to those skilled in the art or disclosed herein may be employed without departing from the invention or the scope of the appended claims. For example, the present invention is not strictly limited to automotive illumination systems, devices, components and methods, but may also be employed in trucks, buses, and other forms of transportation.

Having read and understood the present disclosure, those skilled in the art will now understand that many combinations, adaptations, variations and permutations of known automotive illumination systems, devices, components and methods may be employed successfully in the present invention.

In the claims, means plus function clauses are intended to cover the structures described herein as performing the recited function and their equivalents. Means plus function clauses in the claims are not intended to be limited to structural equivalents only, but are also intended to include structures which function equivalently in the environment of the claimed combination.

All printed publications and patents referenced hereinabove are hereby incorporated by referenced herein, each in its respective entirety.

1. An automotive illumination system, comprising a plurality of LED light sources configured in an array and an LED color control circuit operably connected thereto, the color control circuit being configured to control the color of light emitted by the plurality of LED light sources between at least a first color and a second color, the first color being different from the second color, the color control circuit further comprising an LED drive circuit operably connected to and disposed between the color control circuit and the plurality of LED light sources, the color control circuit further being configured to vary the colors of the plurality of LED light sources across the array in accordance with at least a first predetermined headlight pattern and a second predetermined turn signal pattern, or a third predetermined tail light pattern and a fourth turn signal pattern.

2. The automotive illumination system of claim 1, further comprising at least one light sensor configured to sense the color of light emitted by the plurality of LED light sources, the light sensor being operably connected to the color control circuit, the plurality of LED light sources and the light sensor comprising a feedback control system for controlling and adjusting the color of light emitted by the plurality of LED light sources.

3. The automotive illumination system of claim 2, wherein the light sensor is at least one of a photosensor, a photodiode and a photodetector.

4. The automotive illumination system of claim 2, wherein at least one of the plurality of LED light sources comprises an LED semiconductor and the light sensor is incorporated therein.

5. The automotive illumination system of claim 1, wherein the plurality of LED light sources comprises one or more LED semiconductors.

6. The automotive illumination system of claim 5, wherein the one or more LED semiconductors further comprises at least one light sensor.

7. The automotive illumination system of claim 5, wherein the one or more LED semiconductors further comprises fluorescent material disposed adjacent one or more LEDs thereof.

8. The automotive illumination system of claim 1, wherein the plurality of LED light sources further comprises one or more LED supports.

9. The automotive illumination system of claim 1, wherein the plurality of LED light sources comprises at least one white LED or phosphor-converted white LED.

10. The automotive illumination system of claim 1, wherein the plurality of LED light sources comprises at least one cluster of red, green and blue LEDs.

11. The automotive illumination system of claim 1, wherein the plurality of LED light sources comprises at least one cluster of LEDs comprising at least one LED of a first color and at least one LED of a second color, wherein the first color is different from the second color.

12. The automotive illumination system of claim 11, wherein the LED of a first color is one of an infrared LED, an ultra red LED, a high-efficiency red LED, a super-red LED, a super-orange LED, an orange LED, a super-yellow LED, a super-pure-yellow LED, a yellow LED, an “incandescent” white LED, a pale white LED, a cool white LED, a super-lime-yellow LED, a super-lime-green LED, a high-efficiency green LED, a super-pure-green LED, a pure-green LED, an aqua-green LED, a blue-green LED, super-blue LED, an ultra-blue LED, a violet LED, and a purple LED.

13. The automotive illumination system of claim 11, wherein the LED of a second color is one of an infrared LED, an ultra red LED, a high-efficiency red LED, a super-red LED, a super-orange LED, an orange LED, a super-yellow LED, a super-pure-yellow LED, a yellow LED, an “incandescent” white LED, a pale white LED, a cool white LED, a super-lime-yellow LED, a super-lime-green LED, a high-efficiency green LED, a super-pure-green LED, a pure-green LED, an aqua-green LED, a blue-green LED, super-blue LED, an ultra-blue LED, a violet LED, and a purple LED.

14. The automotive illumination system of claim 1, further comprising at least one environmental sensor configured to sense at least one environmental characteristic, the environmental sensor being operably connected to the color control circuit, the color control circuit and the environmental sensor comprising a feedback control system for controlling and adjusting the color of light emitted by the plurality of LED light sources.

15. The automotive illumination system of claim 14, wherein the environmental sensor is at least one of an external lighting level sensor, an automotive cabin lighting level sensor, on-coming headlight sensor, a rain sensor, a water sensor, a mist sensor, a snow sensor, an ice sensor, a sleet sensor, a fog sensor, a road width sensor, a road condition sensor, a road type sensor, an accelerometer, an automotive speed sensor, a pedestrian sensor, an off-axis vehicle sensor, a moving object sensor, an ignition key sensor, a keyless entry remote control sensor, a door sensor, a trunk sensor, an alarm sensor, a proximity sensor, a seatbelt sensor, and an accident sensor.

16. (canceled)

17. The automotive illumination system of claim 1, wherein the color control circuit is further configured to vary the colors of the plurality of LED light sources spatially across the array.

18. The automotive illumination system of claim 1, wherein the color control circuit is further configured to vary the colors of the plurality of LED light sources in respect of time.

19. The automotive illumination system of claim 1, wherein the color control circuit is further configured to vary the colors of the LED light sources in respect of time and spatially across the array.

20. (canceled)

21. The automotive illumination system of claim 1, wherein the color control circuit is further configured to vary the colors of the plurality of LED light sources according to at least a fifth predetermined pattern that is at least one of a daytime modulator, a turn signal, a tail light, a brake light, a running light, and a fog light, or any combination thereof.

22. The automotive illumination system of claim 1, wherein the system is further configured to operate as a low-beam headlight characterized in having a first set of colors when the color control circuit is in a first state, and as high-beam headlight characterized in having a second set of colors when the color control circuit is in a second state.

23. The automotive illumination system of claim 1, wherein the system is further configured to operate as a headlight characterized in having a first set of colors when the color control circuit is in a first state, and as headlight and a turn signal characterized in having a second set of colors when the color control circuit is in a second state.

24. The automotive illumination system of claim 1, wherein the system is further configured to operate as a headlight characterized in having a first set of colors when the color control circuit is in a first state, and as headlight and a fog light characterized in having a second set of colors when the color control circuit is in a second state.

25. The automotive illumination system of claim 1, wherein the system is further configured to operate as a headlight characterized in having a first set of colors when the color control circuit is in a first state, and as a headlight and a running light characterized in having a second set of colors when the color control circuit is in a second state.

25. The automotive illumination system of claim 1, wherein the system is further configured to operate as a tail light characterized in having a first set of colors when the control circuit is in a first state, and as a tail light characterized in having a second set of colors when the control circuit is in a second state.

27. The automotive illumination system of claim 1, wherein the system is further configured to operate as a tail light when the control circuit is in a first state, and as a tail light and a turn signal when the control circuit is in a second state.

28. The automotive illumination system of claim 1, wherein the system is further configured to operate as a tail light when the control circuit is in a first state, and as a tail light and a brake light when the control circuit is in a second state.

29. The automotive illumination system of claim 1, wherein the system is further configured to operate as a tail light when the control circuit is in a first state, and as a backup light when the control circuit is in a second state.

30. The automotive illumination system of claim 1, further comprising an optical system for collimating light emitted by the plurality of LED light sources.

31. The automotive illumination system of claim 30, wherein the optical system further comprises a reflector.

32. The automotive illumination system of claim 31, wherein the reflector is at least one of a parabolic reflector, an elliptical reflector, a spherical reflector, a spheroidal reflector, an oblate reflector, an oblate spheroidal reflector, a chamfered reflector, and a reflective surface.

33. The automotive illumination system of claim 30, wherein the optical system further comprises a lens.

34. The automotive illumination system of claim 33, wherein the lens is at least one of a projection lens, a condenser lens, a concave lens, a convex lens, a planar lens, a plano-concave lens, a plano-convex lens, a translucent lens, a light-guiding lens, an LED lens, an internally-reflecting lens, a fresnel lens, and an optical color mixer.

35. The automotive illumination system of claim 30, wherein the optical system further comprises at least one of a shade, a diffuser, a screen, a secondary reflector, a retro-reflector, a secondary reflector, a light guide, and an optical manifold.

36. The automotive illumination system of claim 1, wherein the color control circuit further comprises user-controllable means for selecting one or more colors for the plurality of LED light sources.

37. The automotive illumination system of claim 1, wherein the color control circuit further comprises user-controllable means for selecting one or more color patterns for the plurality of LED light sources.

38. The automotive illumination system of claim 1, wherein the color control circuit further comprises manufacturer-controllable hardware or software means for selecting one or more colors for the plurality of LED light sources.

39. The automotive illumination system of claim 1, wherein the color control circuit further comprises manufacturer-controllable hardware or software means for selecting one or more color patterns for the plurality of LED light-sources.

40. The automotive illumination system of claim 1, wherein the system further comprises manufacturer-controllable means for updating or changing software loaded in the color control circuit.

41. The automotive illumination system of claim 1, wherein the color control circuit further comprises at least one of a controller, a micro-controller, a processor, a micro-processor, a processing unit, a CPU, an ASIC, an integrated circuit and a chip.

42. An automotive illumination system, comprising a plurality of LED light sources configured in an array and an LED color control circuit operably connected thereto, the color control circuit being configured to control the power spectral distribution of light emitted by the plurality of LED light sources between at least a first power spectral distribution and a second power spectral distribution, wherein the first power spectral distribution is different from the second power spectral distribution and wavelength-shifted in respect thereof, the color control circuit further comprising an LED drive circuit operably connected to and disposed between the color control circuit and the plurality of LED light sources, the color control circuit further being configured to vary the colors of the plurality of LED light sources across the array in accordance with at least one of a first predetermined headlight pattern and a second predetermined turn signal pattern, or a third predetermined tail light pattern and a fourth turn signal pattern.

43. The automotive illumination system of claim 42, further comprising at least one light sensor configured to sense the color of light emitted by the plurality of LED light sources, the light sensor being operably connected to the color control circuit, the color control circuit, the plurality of LED light sources and the light sensor comprising a feedback control system for controlling and adjusting the color of light emitted by the plurality of LED light sources.

44. An integrated circuit for an automotive illumination system, comprising an LED color control circuit configured to control the color of light emitted by a plurality of LED light sources configured in an array between at least a first power spectral distribution and a second power spectral distribution, wherein the first power spectral distribution is different from the second power spectral distribution and wavelength-shifted in respect thereof the color control circuit being configured to vary the colors of the plurality of LED light sources across the array in accordance with at least one of a first predetermined headlight pattern and a second predetermined turn signal pattern, or a third predetermined tail light pattern and a fourth turn signal pattern.

45. The integrated circuit of claim 44, further comprising means for providing at least one signal corresponding to the output of a light sensor, the integrated circuit and the signal providing means comprising a feedback control system for controlling and adjusting the color of light emitted by the plurality of LED light sources.

46. The integrated circuit of claim 45, wherein the at least one signal providing means comprises an analog-to-digital converter forming a portion of the integrated circuit.

47. The integrated circuit of claim 45, further comprising an LED drive circuit for driving the plurality of LED light sources.

48. A method of controlling the color of light emitted by an automotive illumination system, the system comprising a plurality of LED light sources configured in an array and an LED color control circuit operably connected thereto, the color control circuit being configured to control the color of light emitted by the plurality of LED light sources between at least a first power spectral distribution and a second power spectral distribution, wherein the first power spectral distribution is different from the second power spectral distribution and wavelength-shifted in respect thereof, the color control circuit further being configured to vary the colors of the plurality of LED light sources across the array in accordance with at least a first predetermined headlight pattern and a second predetermined turn signal pattern, or a third predetermined tail light pattern and a fourth turn signal pattern, the method comprising controlling the color of the light emitted by the plurality of LED light sources across the array.

49. A method of adjusting the color of light emitted by an automotive feedback control illumination system, the system comprising a plurality of LED light sources configured in an array and an LED brightness control circuit operably connected thereto, the color control circuit being configured to control the color of light emitted by the plurality of LED light sources between at least a first power spectral distribution and a second spectral power distribution, wherein the first power spectral distribution is different from the second power spectral distribution and wavelength-shifted in respect thereof, and at least one light sensor configured to sense the color of light emitted by the plurality of LED light sources, the light sensor being operably connected to the color control circuit, the color control circuit further being configured to vary the colors of the plurality of LED light sources across the array in accordance with at least one of a first predetermined headlight pattern and a second predetermined turn signal pattern, or a third predetermined tail light pattern and a fourth turn signal pattern the color control circuit, the LED light source and the light sensor comprising a feedback control system for controlling and adjusting the colors of light emitted by the plurality of LED light sources, the method comprising adjusting the colors of the light emitted by the plurality of LED light sources across the array using the feedback control system.

50. A method of making an automotive illumination system, the system comprising a plurality of LED light sources configured in an array and an LED color control circuit operably connected thereto, the color control circuit being configured to control the colors of light emitted by the plurality of LED light sources between at least a first power spectral distribution and a second power spectral distribution and wavelength-shifted in respect thereof wherein the first power spectral distribution is different from the second power spectral distribution, the color control circuit being configured to vary the colors of the plurality of LED light sources across the array in accordance with at least one of a first predetermined headlight pattern and a second predetermined turn signal pattern, or a third predetermined tail light pattern and a fourth turn signal pattern the method comprising providing the automotive illumination system.

51. A method of making an automotive feedback control illumination system, the system comprising a plurality of LED light sources configured in an array and an LED color control circuit operably connected thereto, the color control circuit being configured to control the colors of light emitted by the plurality of LED light sources between at least a first power spectral distribution and a second spectral power distribution, wherein the first power spectral distribution is different from the second power spectral distribution and wavelength-shifted in respect thereof, and at least one light sensor configured to sense the colors of light emitted by the plurality of LED light sources, the light sensor being operably connected to the color control circuit, the color control circuit being configured to vary the colors of the plurality of LED light sources across the array in accordance with at least one of a first predetermined headlight pattern and a second predetermined turn signal pattern, or a third predetermined tail light pattern and a fourth turn signal pattern. the color control circuit, the LED light source and the light sensor comprising a feedback control system for controlling and adjusting the color of light emitted by the plurality of LED light sources, the method comprising providing the automotive feedback control illumination system.

52. A method of installing an automotive illumination system, the system comprising a plurality of LED light sources configured in an array and an LED color control circuit operably connected thereto, the color control circuit being configured to control the colors of light emitted by the plurality of LED light sources between at least a first power spectral distribution and a second power spectral distribution, wherein the first power spectral distribution is different from the second power spectral distribution and wavelength-shifted in respect thereof, the color control circuit being configured to vary the colors of the plurality of LED light sources across the array in accordance with at least one of a first predetermined headlight pattern and a second predetermined turn signal pattern, or a third predetermined tail light pattern and a fourth turn signal pattern, the method comprising installing the automotive illumination system in an automobile.

53. A method of installing an automotive feedback control illumination system, the system comprising a plurality of LED light sources configured in an array and an LED color control circuit operably connected thereto, the color control circuit being configured to control the colors of light emitted by the plurality of LED light sources between at least a first power spectral distribution and a second spectral power distribution, wherein the first power spectral distribution is different from the second power spectral distribution and wavelength-shifted in respect thereof, and at least one light sensor configured to sense the colors of light emitted by the plurality of LED light sources, the light sensor being operably connected to the color control circuit, the color control circuit further being configured to vary the colors of the plurality of LED light sources across the array in accordance with at least one of a first predetermined headlight pattern and a second predetermined turn signal pattern, or a third predetermined tail light pattern and a fourth turn signal pattern, the plurality of LED light sources and the light sensor comprising a feedback control system for controlling and adjusting the colors of light emitted by the plurality of LED light sources across the array, the method comprising installing the automotive feedback control illumination system in an automobile.
